(19) United States
(12) Patent Application Publication
(10) Pub. No.: US 2004/0133527 A1
(43) Pub. Date: Jul. 8, 2004

(54) Estimation system, estimation method, and program for harness processing

(76) Inventors: Michikazu Sakurai, Saitama (JP); Takashi Nakahara, Kanagawa (JP); Daiho Sakuragi, Kanagawa (JP); Yohichiroh Mukunoki, Tokyo (JP); Hideyuki Fukuma, Kanagawa (JP); Yoshinori Takekoshi, Tokyo (JP); Masayuki Ueda, Kanagawa (JP); Fuminari Yashiro, Kanagawa (JP); Jun Sugawara, Kanagawa (JP); Katsumi Otsuka, Saga (JP)

Correspondence Address: MORRISON & FOERSTER LLP, 1650 TYSONS BOULEVARD, SUITE 300, MCLEAN, VA, 22102, US

(21) Appl. No.: 10/667,198

(22) Filed: Sep. 22, 2003

(30) Foreign Application Priority Data
Sep. 20, 2002 (JP) 2002-275299

(51) Int. Cl. G06F 17/00

(52) U.S. Cl. 705/400; 700/117

(57) ABSTRACT

An estimation system has a storage unit which stores an estimation function for calculating a unit component price of a harness based on a designated processing condition, an input unit which acquires the processing condition from an estimation requester, and a control unit which calculates the unit component price of the harness based on the processing condition designated by the estimation requester and the estimation function read out from the storage unit, and stores the calculated unit component price in the storage unit.

### BACKGROUND OF THE INVENTION.

1. Field of the Invention

The present invention relates to an estimation system, an estimation method and a program for harness processing.

2. Description of the Related Art

A harness incorporated into cars and various electronic apparatuses as their component is constituted by making insulation-displacement-crimping (IDC) or crimp-connecting (CC) of connectors to both ends of a plurality of electric wires. In the manufacturing process of a harness, processing instruments such as a crimp-connecting machine and an insulation-displacement-crimping machine are used.

It is important to grasp how much it costs to manufacture a harness by using the above-mentioned processing instruments, and to grasp beforehand the time required in each process step, in order to realize a higher efficiency for harness designing, a success in a negotiation, and optimization of process step management and staff member allocation. Accordingly, there has been a demand for realization of an estimation system which receives input of manufacturing conditions of a harness for which estimation is requested, and can quickly output a highly objective manufacturing cost of the harness required if the harness is manufactured with the input manufacturing conditions.

Unexamined Japanese Patent Application KOKAI Publication No. 2000-285123 discloses a computer system which memorizes and outputs prices of various kinds of components. However, the computer system can not estimate the components. More specifically, it can not estimate the time and cost to manufacture components, time and cost required in each process step for manufacturing the components, and so on.

### SUMMARY OF THE INVENTION

An object of the present invention made under such situations is to provide an estimation system, an estimation method, and a program for making it possible to quickly output an estimated cost for manufacturing a harness, which is in accordance with manufacturing conditions designated by the estimation requester.

To achieve the above object, an estimation system for harness processing according to a first aspect of the present invention comprises: a storage unit which is constituted by a memory medium or memory elements, and which stores an estimation function for calculating an estimation of a harness based on a designated processing condition for processing the harness; an input unit which receives input of information; and a control circuit which calculates the estimation of the harness based on the estimation function read out from the storage unit and the processing condition designated from the input unit.

The estimation system for harness processing may comprise a communication unit which receives the estimation function and stores the received estimation function in said storage unit.

The input unit may comprise a communication unit which receives the processing condition from an external terminal and provides the received processing condition to the control circuit, and sends an estimation result for the harness calculated by the control circuit to the external terminal. In this case, the external terminal to which the estimation result is sent is a specific terminal, and the control circuit may confirm that the external terminal is the specific terminal until at least before the estimation result is sent to the external terminal, and then may send the estimation result to the external terminal via the communication unit.

The estimation function for the harness may be a function for calculating a unit component price of the harness based on the processing condition for the harness.

The estimation system for harness processing may comprise an output unit which outputs information, and the control circuit may perform a1) a step of acquiring the processing condition for the harness which is designated from the input unit, b1) a step of storing the designated processing condition in the storage unit, c1) a step of reading out the designated processing condition from the storage unit, d1) a step of reading out the estimation function from the storage unit, e1) a step of calculating the unit component price of the harness that corresponds to the designated processing condition, based on the read-out estimation function and a content of the designated processing condition, f1) a step of storing the calculated unit component price in the storage unit, g1) a step of reading out the unit component price from the storage unit, and h1) a step of outputting the read-out unit component price via the output unit.

The estimation function stored in the storage unit may be an operation time estimation function for calculating, based on the processing condition, an instrument operation time of each process step for processing the harness by using a harness processing instrument.

In this case, the control circuit may perform a2) a step of acquiring the processing condition designated for each process step via the input unit, b2) a step of storing the designated processing condition in the storage unit, c2) a step of reading out the designated processing condition from the storage unit, d2) a step of reading out the operation time estimation function from the storage unit, e2) a step of calculating the instrument operation time of each process step based on the read-out operation time estimation function and the designated processing condition, and f2) a step of storing the calculated instrument operation time of each process step in the storage unit.

The “instrument operation time” is a time during which a processing instrument is operated for processing the harness for which estimation is to be made.

Further, the storage unit may store an operation cost estimation function for calculating, based on the instrument operation time, an instrument operation cost that is required for processing the harness using the harness processing instrument, and the control circuit may perform a3) a step of reading out the calculated instrument operation time of each process step from the storage unit, b3) a step of reading out the operation cost estimation function from the storage unit, c3) a step of calculating the instrument operation cost of each process step based on the read-out instrument operation time of each process step and the operation cost estimation function, and d3) a step of storing the calculated instrument operation cost of each process step in the storage unit. The “instrument operation cost” is a material cost arising from operating the harness processing instrument.

Further, the storage unit may store a work time estimation function for calculating an instrument work time which is required for processing the harness using the harness processing instrument, based on the designated processing condition, and the control circuit may perform a4) a step of reading out the work time estimation function from the storage unit, b4) a step of calculating the instrument work time of each process step based on the read-out work time estimation function and the designated processing condition, and c4) a step of storing the calculated instrument work time of each process step in the storage unit. The “instrument work time” is a time during which a worker using the harness processing instrument does his/her works for processing the harness for which estimation is to be made.

Further, the storage unit stores a labor cost estimation function for calculating, based on the instrument work time, an instrument labor cost that is required for processing the harness using the harness processing instrument, and the control circuit may perform a5) a step of reading out the calculated instrument work time of each process step from the storage unit, b5) a step of reading out the labor cost estimation function from the storage unit, c5) a step of calculating the instrument labor cost of each process step based on the read-out instrument work time of each process step and the labor cost estimation function, and d5) a step of storing the calculated instrument labor cost of each process step in the storage unit. The “instrument labor cost” is a labor cost (personnel expense) arising from operating the harness processing instrument.

Further, the storage unit may store a planning time estimation function for calculating, based on the designated processing condition, a planning time before processing the harness using the harness processing instrument, and the control circuit may perform a6) a step of reading out the planning time estimation function from the storage unit, b6) a step of calculating the planning time of each process step based on the read-out planning time estimation function and the designated processing condition, and c6) a step of storing the calculated planning time of each processing step in the storage unit. The “planning time” is a time required for preparation in a stage before operating the harness processing instrument.

Further, the storage unit may store a planning cost estimation function for calculating, based on the planning time, a planning cost required for processing the harness using the harness processing instrument, and the control circuit may perform a7) a step of reading out the calculated planning time of each process step from the storage unit, b7) a step of reading out the planning cost estimation function from the storage unit, c7) a step of calculating the planning cost of each process step based on the read-out planning time of each process step and the planning cost estimation function, and d7) a step of storing the calculated planning cost of each process step in the storage unit. The “planning cost” includes a material cost and a labor cost arising in the stage before operating the harness processing instrument.

Further, the control circuit performs a8) a step of reading out the calculated instrument operation cost, instrument labor cost, and planning cost of each process step from the storage unit, b8) a step of calculating a processing cost required for processing the harness using the harness processing instrument, by adding up the read-out instrument operation cost, instrument labor cost, and planning cost, and c8) a step of storing the calculated processing cost in the storage unit.

The estimation system may further comprise an output unit which outputs information, and the control circuit may perform a9) a step of reading out the calculated processing cost from the storage unit, and b9) a step of outputting the read-out processing cost via the output unit.

Further, the control circuit may perform a10) a step of reading out the calculated instrument operation time, instrument work time, and planning time from the storage unit, and b10) a step of outputting the read-out instrument operation time, instrument work time, and planning time via the output unit.

To achieve the above object, an estimation system according to a second aspect of the present invention comprises: a storage unit which stores information; an input unit which receives input of information; and a control circuit which controls operations of the storage unit and input unit, the storage unit stores a component database associating a quantity of child components necessary for manufacturing each harness and a unit child component price of the child components with identification information of each harness, and also stores a material cost estimation function for calculating a material cost of each harness by inputting thereto, the quantity and the unit child component price, and the control circuit performs a11) a step of acquiring identification information of a harness for which estimation is to be made via the input unit, b11) a step of reading out the quantity and the unit child component price associated with the acquired identification information of the harness from the component database in the storage unit, c11) a step of reading out the material cost estimation function from the storage unit, d11) a step of calculating the material cost of the harness corresponding to the acquired identification information, based on the read-out material cost estimation function and the read-out quantity of child components and unit child component price, and e11) a step of storing the calculated material cost in the storage unit.

In this case, the estimation system may comprise an output unit which outputs information, and the control circuit may perform a12) a step of creating a component screen displaying the read-out quantity of child components and unit child component price, and outputting the created component screen via the output unit, b12) a step of acquiring a change of the quantity of child components and/or unit child component price displayed on the component screen, via the input unit, and c12) a step of calculating the material cost of the harness based on the changed quantity and unit child component price and the material cost estimation function.

To achieve the above object, an estimation method according to a third aspect of the present invention is a method for causing a control circuit to calculate an estimation of a harness based on an estimation function read out from a storage unit and a processing condition designated from an input unit, in a system comprising: the storage unit which is constituted by a memory medium or memory elements, and which stores the estimation function for calculating an estimation of a harness based on a designated processing condition for processing the harness; the control circuit; and the input unit which receives input of information.

A communication unit may be provided to the system, and the estimation method may cause the communication unit to receive the estimation function and store the received estimation function in the storage unit.

A communication unit may be provided to the input unit, and the estimation method may cause the communication unit to receive the processing condition from an external terminal, provide the received processing condition to the control circuit, and send an estimation result for the harness calculated by the control circuit to the external terminal.

To achieve the above object, a program according to a fourth aspect of the present invention controls a control circuit to perform an operation of calculating an estimation of a harness based on an estimation function read out from a storage unit and a processing condition designated from an input unit, in a system comprising: the storage unit which is constituted by a memory medium or memory elements, and which stores the estimation function for calculating an estimation of a harness based on a designated processing condition for processing the harness; the input unit which receives input of information; and the control circuit.

The system may comprise a communication unit which receives the estimation function and stores the received estimation function in the storage unit.

The input unit may comprise a communication unit which receives the processing condition from an external terminal, provides the received processing condition to the control circuit, and sends an estimation result for the harness calculated by the control circuit to the external terminal.

In this case, the external terminal to which the estimation result is sent may be a specific terminal, and the program may control the control circuit to confirm that the external terminal is the specific terminal until at least before the estimation result is sent to the external terminal, and then send the estimation result to the external terminal via the communication unit.

The estimation function for the harness may be a function for calculating a unit component price of the harness based on the processing condition for the harness.

In this case, the system may comprise an output unit which outputs information; and the program may control the control circuit to perform a1) a step of acquiring the processing condition for the harness which is designated from the input unit, b1) a step of storing the designated processing condition in the storage unit, c1) a step of reading out the designated processing condition from the storage unit, d1) a step of reading out the estimation function from the storage unit, e1) a step of calculating the unit component price of the harness that corresponds to the designated processing condition, based on the read-out estimation function and a content of the designated processing condition, f1) a step of storing the calculated unit component price in the storage unit, g1) a step of reading out the unit component price from the storage unit, and h1) a step of outputting the read-out unit component price via the output unit.

In this case, the estimation function stored in the storage unit may be an operation time estimation function for calculating, based on the processing condition, an instrument operation time of each process step for processing the harness during which a harness processing instrument is operated.

Further, the program may control the control circuit to perform: a2) a step of acquiring the processing condition designated for each process step via the input unit, b2) a step of storing the designated processing condition in the storage unit, c2) a step of reading out the designated processing condition from the storage unit, d2) a step of reading out the operation time estimation function from the storage unit, e2) a step of calculating the instrument operation time of each process step based on the read-out operation time estimation function and the designated processing condition, and f2) a step of storing the calculated instrument operation time of each process step in the storage unit.

Further, the storage unit may store an operation cost estimation function for calculating, based on the instrument operation time, an instrument operation cost that is required for processing the harness using the harness processing instrument, and the program may control the control circuit to perform a3) a step of reading out the calculated instrument operation time of each process step from the storage unit, b3) a step of reading out the operation cost estimation function from the storage unit, c3) a step of calculating the instrument operation cost of each process step based on the read-out instrument operation time of each process step and the operation cost estimation function, and d3) a step of storing the calculated instrument operation cost of each process step in the storage unit.

Further, the storage unit may store a work time estimation function for calculating an instrument work time which is required for processing the harness using the harness processing instrument, based on the designated processing condition, and the program may control the control circuit to perform: a4) a step of reading out the work time estimation function from the storage unit, b4) a step of calculating the instrument work time of each process step based on the read-out work time estimation function and the designated processing condition, and c4) a step of storing the calculated instrument work time of each process step in the storage unit.

Further, the storage unit may store a labor cost estimation function for calculating, based on the instrument work time, an instrument labor cost that is required for processing the harness using the harness processing instrument, and the program may control the control circuit to perform a5) a step of reading out the calculated instrument work time of each process step from the storage unit, b5) a step of reading out the labor cost estimation function from the storage unit, c5) a step of calculating the instrument labor cost of each process step based on the read-out instrument work time of each process step and the labor cost estimation function, and d5) a step of storing the calculated instrument labor cost of each process step in the storage unit.

Further, the storage unit may store a planning time estimation function for calculating, based on the designated processing condition, a planning time before processing the harness using the harness processing instrument, and the program may control the control circuit to perform: a6) a step of reading out the planning time estimation function from the storage unit, b6) a step of calculating the planning time of each process step based on the read-out planning time estimation function and the designated processing condition, and c6) a step of storing the calculated planning time of each processing step in the storage unit.

Further, the storage unit may store a planning cost estimation function for calculating, based on the planning time, a planning cost required for processing the harness using the harness processing instrument, and the program may control the control circuit to perform: a7) a step of reading out the calculated planning time of each process step from the storage unit, b7) a step of reading out the planning cost estimation function from the storage unit, c7) a step of calculating the planning cost of each process step based on the read-out planning time of each process step and the planning cost estimation function, and d7) a step of storing the calculated planning cost of each process step in the storage unit.

Further, the program may control the control circuit to perform: a8) a step of reading out the calculated instrument operation cost, instrument labor cost, and planning cost of each process step from the storage unit, b8) a step of calculating a processing cost required for processing the harness using the harness processing instrument, by adding up the read-out instrument operation cost, instrument labor cost, and planning cost, and c8) a step of storing the calculated processing cost in the storage unit.

The system may comprise an output unit which outputs information, and the program may control the control circuit to perform: a9) a step of reading out the calculated processing cost from the storage unit, and b9) a step of outputting the read-out processing cost via the output unit.

The program may control the control circuit to perform: a10) a step of reading out the calculated instrument operation time, instrument work time, and planning time from the storage unit, and b10) a step of outputting the read-out instrument operation time, instrument work time, and planning time via the output unit.

The present invention is structured as described above and functions as described above. Therefore, the present invention can provide an estimation system which quickly outputs an estimated value of a harness in accordance with a processing condition designated by an estimation requester.

### BRIEF DESCRIPTION OF THE DRAWINGS

These objects and other objects and advantages of the present invention will become more apparent upon reading of the following detailed description and the accompanying drawings in which:

FIG. 1 is a block diagram showing an entire structure of an estimation system according to a first embodiment of the present invention;

FIG. 2 is a diagram showing a main screen;

FIG. 3 is a diagram showing a processing information screen for insulation-displacement-crimping;

FIG. 4 is a diagram showing an example of a navigator display section;

FIG. 5 is a diagram showing a processing information screen for crimp-connecting;

FIG. 6 is a diagram showing a processing information screen for wiring preparation works/wiring;

FIG. 7 is a diagram showing a processing information screen for wiring-related works/continuity check/appearance check;

FIG. 8 is a flowchart showing a processing cost calculation operation;

FIG. 9 is a diagram showing a table defining operation times;

FIG. 10 is a diagram showing a table defining operation times;

FIG. 11 is a diagram showing a table defining operation times;

FIG. 12 is a diagram showing a table defining operation times;

FIG. 13 is a diagram showing a table defining operation times;

FIG. 14 is a diagram showing a table defining operation times;

FIG. 15 is a diagram showing a table defining operation times;

FIG. 16 is a diagram showing a table defining operation times;

FIG. 17 is a diagram showing a table defining operation times;

FIG. 18 is a diagram showing a table defining operation times;

FIG. 19 is a diagram showing a table defining operation times;

FIG. 20 is a diagram showing a table defining operation times;

FIG. 21 is a diagram showing a table defining operation times;

FIG. 22 is a diagram showing a table defining operation times;

FIG. 23 is a diagram showing a time factor setting table;

FIG. 24 is a diagram showing a processing cost ratio master table;

FIG. 25 is a diagram showing a unit component price screen;

FIG. 26 is a diagram showing a processing cost display screen;

FIG. 27 is a diagram showing an insulation-displacement-crimping step setting screen;

FIG. 28 is a diagram showing a crimp-connecting step setting screen;

FIG. 29 is a flowchart of an insulation-displacement-crimping machine selection operation;

FIG. 30 is a flowchart of a crimp-connecting machine selection operation;

FIG. 31 is a diagram showing a process step setting table;

FIG. 32 is a diagram showing a process step setting table;

FIG. 33 is diagram showing a processing information screen for wiring-related works/continuity check/appearance check;

FIG. 34 is a diagram showing an environmental impact information table;

FIG. 35 is a block diagram showing a structure of an estimation system according to a second embodiment;

FIG. 36 is a flowchart showing an estimation method of the estimation system shown in FIG. 35.

FIG. 37 is a block diagram showing a structure of an estimation system according to a third embodiment; and

FIG. 38 is a flowchart showing an estimation method of the estimation system shown in FIG. 37.

### DETAILED DESCRIPTION OF THE PREFERRED EMBODIMENTS

The embodiments of the present invention will now be explained with reference to the drawings.

[First Embodiment]

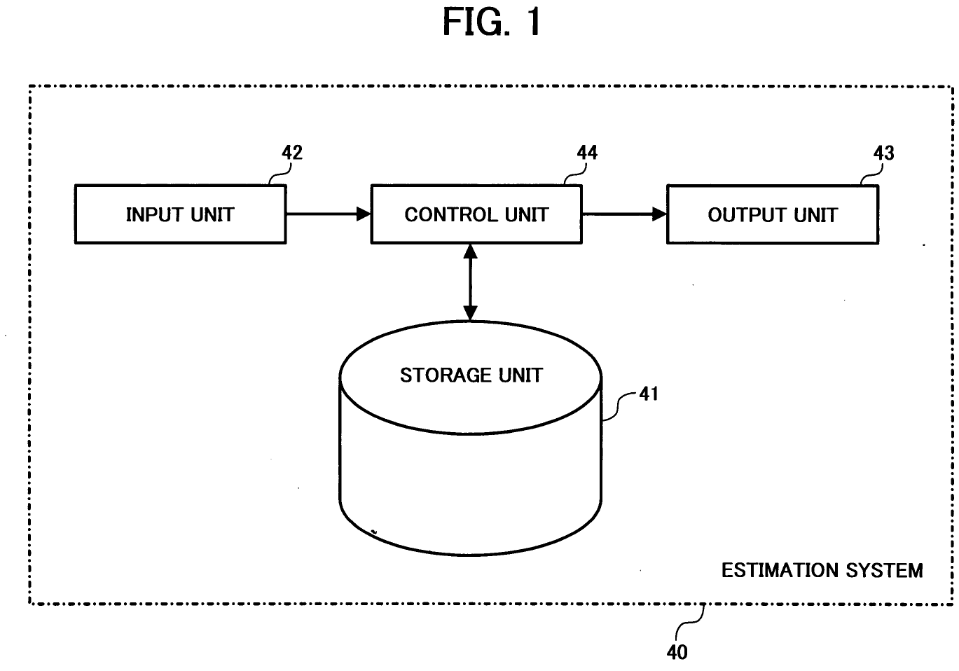

FIG. 1 is a block diagram showing the entire structure of an estimation system 40 for harness processing, according to a first embodiment of the present invention.

The estimation system 40 comprises a storage unit 41, an input unit 42, an output unit 43, and a control unit 44.

The storage unit 41 can be constituted by, for example, a RAM (Random Access Memory) constituted by storage elements, a ROM (Read Only Memory), a hard disk, or various recording media.

Physically, the storage unit 41 may be constituted by one unit, or may be constituted by a plurality of units.

The storage unit 41 stores an estimation function for calculating a unit component price of a harness. The unit component price of a harness can be broken down into a material cost, a processing cost, a material loss cost, a material management cost, a general management cost, a profit margin, a transportation cost, and a transportation/material handling cost. The storage unit 41 stores a function for calculating an estimation for each of these cost categories. The storage unit 41 further stores a table defining calculation factors to be input to the estimation function. The storage unit 41 further stores a component database in which the quantity of child components necessary for manufacturing each harness and unit price of the child component are associated with identification information of each harness, and a unit component price database.

The input unit 42 includes, for example, a keyboard and a pointing device such as a mouse.

The output unit 43 is, for example, a computer display.

The control unit 44 comprises, for example, a CPU (Central Processing Unit) as a control circuit. The control unit 44 may further comprise a plurality of calculation means for performing a distribution operation.

As described above, the unit component price of a harness is made up of a material cost, a processing cost, a material loss cost, a material management cost, a general management cost, a profit margin, a transportation cost, and a transportation/material handling cost, and the unit component price is calculated by adding up these costs. The estimated cost for each of these cost categories is calculated based on information input from a processing condition input screen and the estimation function stored in the storage unit 41. Therefore, the structure of the processing condition input screen will be explained first.

The processing condition input screen according to the present embodiment includes a main screen and a processing information screen shifted from the main screen.

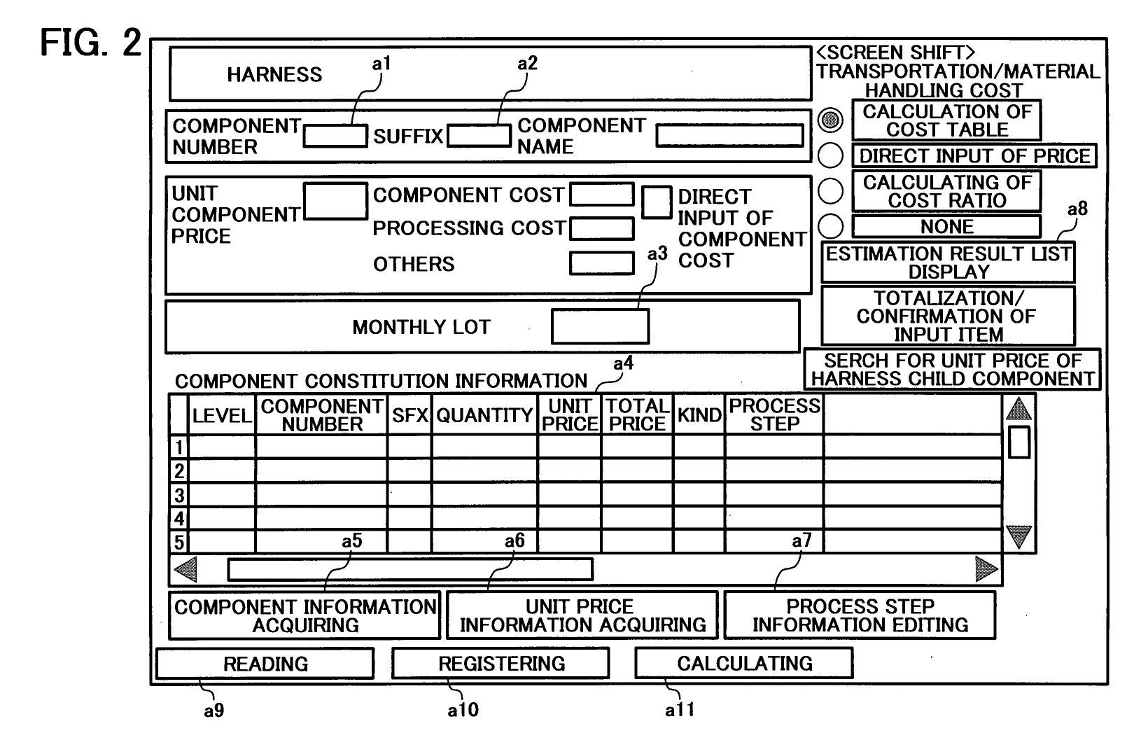

FIG. 2 is a diagram showing the main screen.

A component number input section a1 and a suffix input section a2 are arranged in an upper row of the main screen. According to the present embodiment, it is arranged that when estimation for a harness is conducted, information on child components constituting the harness for which the estimation is conducted should be stored as log data. This is for making it possible for other people to read out the log afterwards and use it. The component number and suffix are used as identifies for this estimation log.

A monthly lot input section a3 is provided in a middle row of the main screen. A monthly production quantity of a harness for which estimation should be conducted is input in this section a3.

A component constitution information section a4 is further provided in a middle row of the main screen. The level, component number, suffix (SFX), quantity, unit price, total price, kind, etc. are indicated in the component constitution information section a4. The sum total of the prices indicated in this section is appropriated as a material cost.

An estimation requester can directly input a component number in the component constitution information section a4. Further, the estimation requester can call data which was input in the past when others conducted estimation. Furthermore, the estimation requester can modify the called data and input the modified data. As described above, it is arranged that a component number and a suffix should be stored as identifiers when estimation for a harness is conducted.

Accordingly, when an estimation requester, who knows that another person has ever conducted estimation for a harness having the same component number, clicks a reading button a9 in a lower row of the main screen, the main screen shifts to a predetermined data reading screen. The estimation requester can call a desired estimation log and make the log displayed in the component constitution information section a4, by specifying a component number and a suffix in this data reading screen. Due to this, it is possible to save the labor and time to be cost for the estimation requester to input all of the component number, quantity, unit price, etc. of the child component constituting the harness.

However, the estimation requester may not use the log. In this case, when the estimation requester inputs a component number in the component number input section a1 and a suffix in the suffix input section a2 and then clicks a component information acquiring button a5, the control unit 44 automatically acquires the level, component number, suffix, and quantity of each child component necessary for manufacturing the harness corresponding to the input component number, and displays the acquired data in the component constitution information section a4.

The storage unit 41 of the estimation system 40 stores a component database. The component database associates a component number and suffix which are identifiers of a harness, with a component number, suffix, level, quantity of each child component necessary for manufacturing the harness.

Accordingly, when the component information acquiring button a5 is selected, the control unit 44 reads out information on the corresponding child component from the component database by using the component number and suffix as keys, and displays the read-out information. Further, the storage unit 41 stores a unit component price database in which the component number of each child component and the unit price of the child component are associated with each other. When the estimation requester selects a unit price information acquiring button a6 in the lower row of the screen, the control unit 44 reads out a unit price that corresponds to the component number of each child component displayed in the component constitution information section a4, and displays the read-out unit price.

However, the unit price can also be directly input by the estimation requester.

The control unit 44 marks the field “kind” in the component constitution information section a4 with “master” when a unit price is read out from the unit component price database, and marks the field with “input” when a unit price is directly input.

Then, the control unit 44 estimates the material cost of a harness based on the quantity and unit price which are read out or directly input to the component constitution information section a4.

As explained above, the estimation system 40 can simplify the estimation requester's work for inputting factors necessary for estimating the material cost, by providing a service that is linked with the component database and the unit component price database.

When the estimation requester clicks a registering button a10 in the lowermost row of the main screen, the information on the child component which is displayed in the component constitution information section a4 at the time the button a10 is clicked is stored as an estimation log. This estimation log is stored by using the component number and suffix as identifiers. Therefore, the estimation requester, who calls an estimation log in the past, must click the registering button a10 after changing the suffix in the suffix input section a2 to another one.

The main screen shifts to a processing information screen in response to a click on a process step information editing button a7 arranged under the component constitution information section a4.

The processing information screen is for inputting a calculation factor necessary for estimating a processing cost for each process step. Process steps include four kinds of process steps, namely, a process step for crimp-connecting, a process step for insulation-displacement-crimping, a process step for wiring preparation works/wiring, and a process step for wiring-related works/continuity check/appearance check.

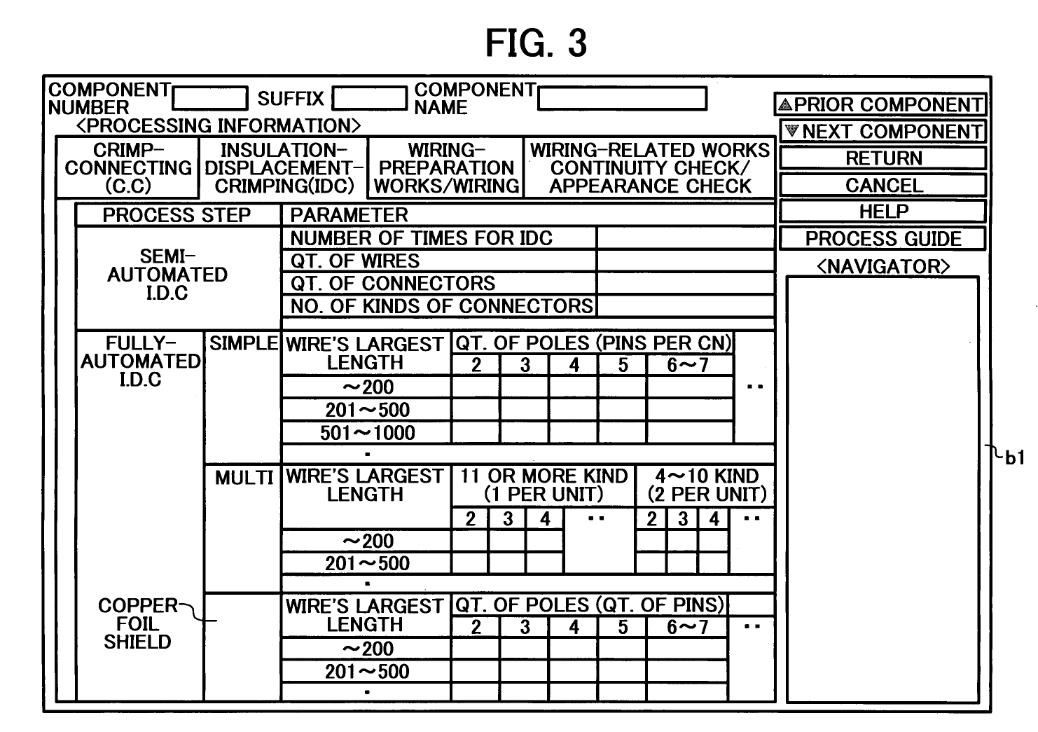

FIG. 3 shows a processing information screen for insulation-displacement-crimping.

The processing information screen has input sections for inputting calculation factors necessary for calculating a processing cost required in the process step for insulation-displacement-crimping. The process step for insulation-displacement-crimping includes semi-automated insulation-displacement-crimping (SAIDC) and fully-automated insulation-displacement-crimping (FAIDC). The fully-automated insulation-displacement crimping is classified into three kinds, namely, simple, multi, and copper foil shied.

The processing information screen for insulation-displacement-crimping will now be specifically explained.

In the processing information screen for insulation-displacement-crimping, input sections for inputting a number of times for carrying out insulation-displacement-crimping, a quantity of wires, a quantity of connectors, a number of kinds of connectors are provided for semi-automated insulation-displacement-crimping. In the processing information screen for insulation-displacement-crimping, input sections for inputting quantities of poles required for respective categories of wire's largest length are provided for fully-automated insulation-displacement-crimping (simple). In the processing information screen for insulation-displacement-crimping, input sections for inputting quantities of poles required for respective categories of wire's largest length are provided for fully-automated insulation-displacement-crimping (multi). In the processing information screen for insulation-displacement-crimping, input sections for inputting quantities of poles required for respective categories of wire's largest length are provided for fully-automated insulation-displacement-crimping (copper foil shield).

Further, a navigator display section b1 is provided in the right of the processing information screen for insulation-displacement-crimping.

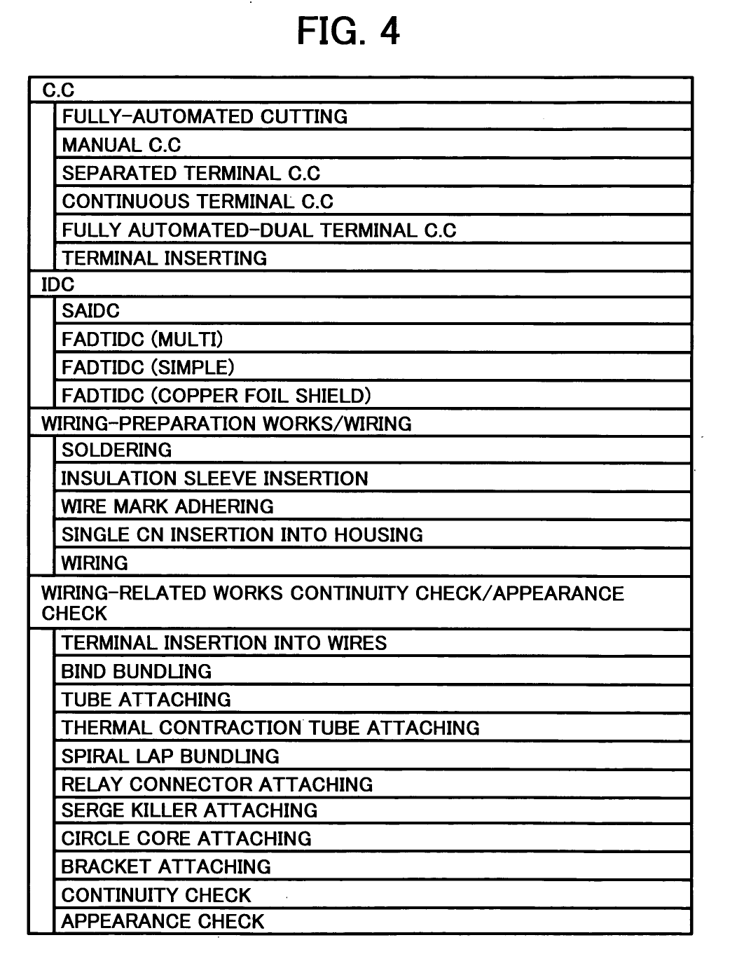

FIG. 4 is a diagram showing an example of the navigator display section b1.

The navigator display section b1 indicates, based on which of crimp-connecting, insulation-displacement-crimping, wiring preparation works/wiring, and wiring-related works/continuity check/appearance check, a calculation factor of each process step is categorized. Accordingly, the estimation requester can understand the processing information screen for inputting calculation factors necessary for manufacturing a harness for which estimation is requested, at first glance.

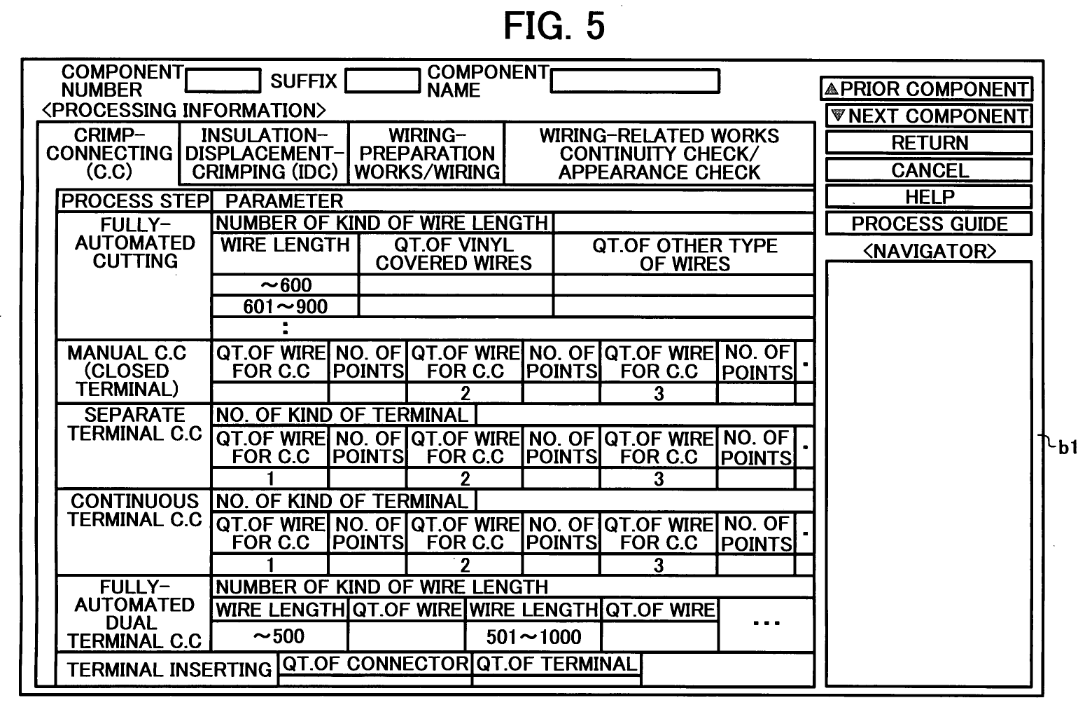

FIG. 5 shows a processing information screen for crimp-connecting. In this screen, input sections for inputting calculation factors necessary for calculating a processing cost required in the process step for crimp-connecting. The process step for crimp-connecting includes fully-automated cutting, manual crimp-connecting (closed terminal), separate terminal crimp-connecting (resin-covered circle terminal), continuous terminal crimp-connecting, fully-automated dual terminal crimp-connecting (FADTCC), terminal inserting.

In the processing information screen for crimp-connecting, input sections for inputting number of kinds of wire lengths, a quantity of vinyl-covered wires for respective “wire length” categories, and a quantity of other types of wires for respective “wire length” categories are provided for fully-automated cutting. In this screen, input sections for inputting numbers of points for crimp-connecting for respective “quantity of wires for crimp-connecting” categories are provided for manual crimp-connecting (closed terminal). In this screen, input sections for inputting number of kinds of terminals, and numbers of points for crimp-connecting for respective “quantity of wires for crimp-connecting” categories are provided for separate terminal crimp-connecting (resin-covered circle terminal). In this screen, input sections for inputting number of kinds of terminals, and numbers of points for crimp-connecting for respective “quantity of wires for crimp-connecting” categories are provided for continuous terminal crimp-connecting. In this screen, input sections for inputting number of kinds of wire lengths, and quantities of wires for respective “wire length” categories are provided for fully-automated dual terminal crimp-connecting. In this screen, input sections for inputting a quantity of connectors and a quantity of terminals are provided for terminal inserting.

The navigator display section b1 is also provided in the right of the processing information screen shown in FIG. 5.

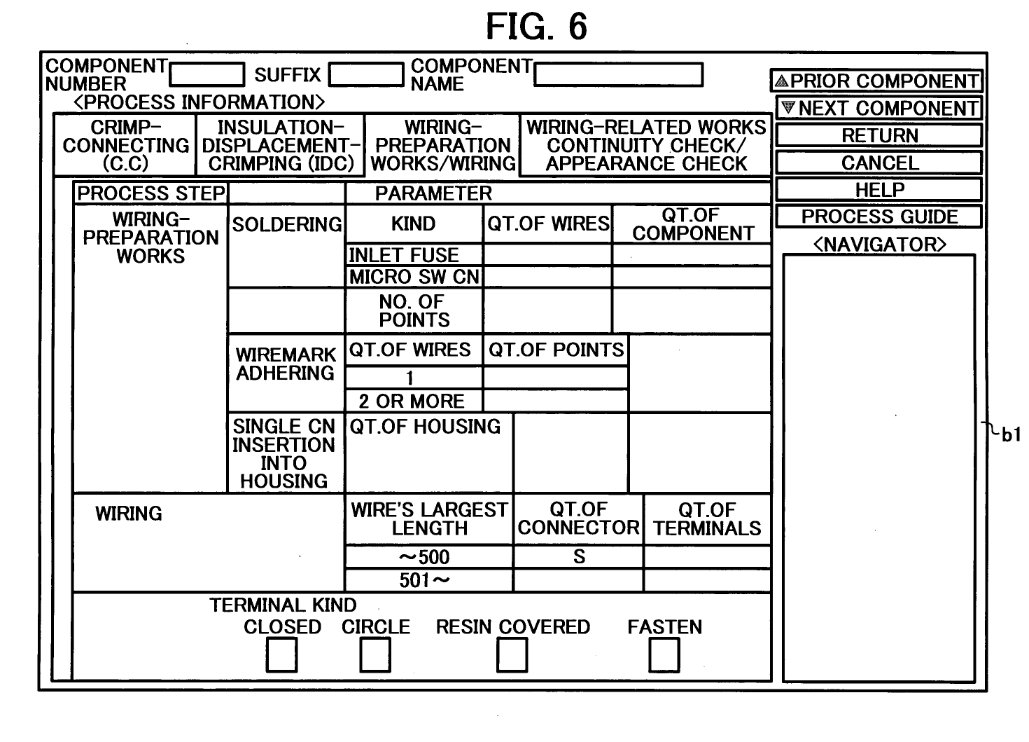

FIG. 6 is a processing information screen for wiring preparation works/wiring. This processing information screen has inputting sections for inputting calculation factors necessary for calculating a processing cost required in the process step for wiring preparation works/wiring. The wiring preparation works are classified into four categories, namely soldering, insulation sleeve insertion, wire mark adhering, and single connector insertion into housing (hereinafter, a single connector will be referred to as single CN).

In the processing information screen for wiring preparation works/wiring, input sections for inputting quantities of wires to which each of an inlet fuse, a micro switch (hereinafter, referred to as micro SW), and a connector is attached, and quantities of components are provided for soldering in wiring preparation works. In this screen, an input section for inputting a number of points for insertion is provided for insulation sleeve insertion in wiring preparation works. In this screen, input sections for inputting numbers of points to which a wire mark is adhered for respective “quantity of wires” categories (one or two) are provided for wire mark adhering in wiring preparation works. In this screen, an input section for inputting a quantity of housings is provided for single CN insertion into housing in wiring preparation works. In this screen, input sections for inputting quantities of connectors and quantities of terminals (for closed terminals, circle terminals, and faston terminals only) for respective “wire's largest length” categories are provided for wiring.

The navigator display section b1 is also provided in the right of the processing information screen shown in FIG. 6.

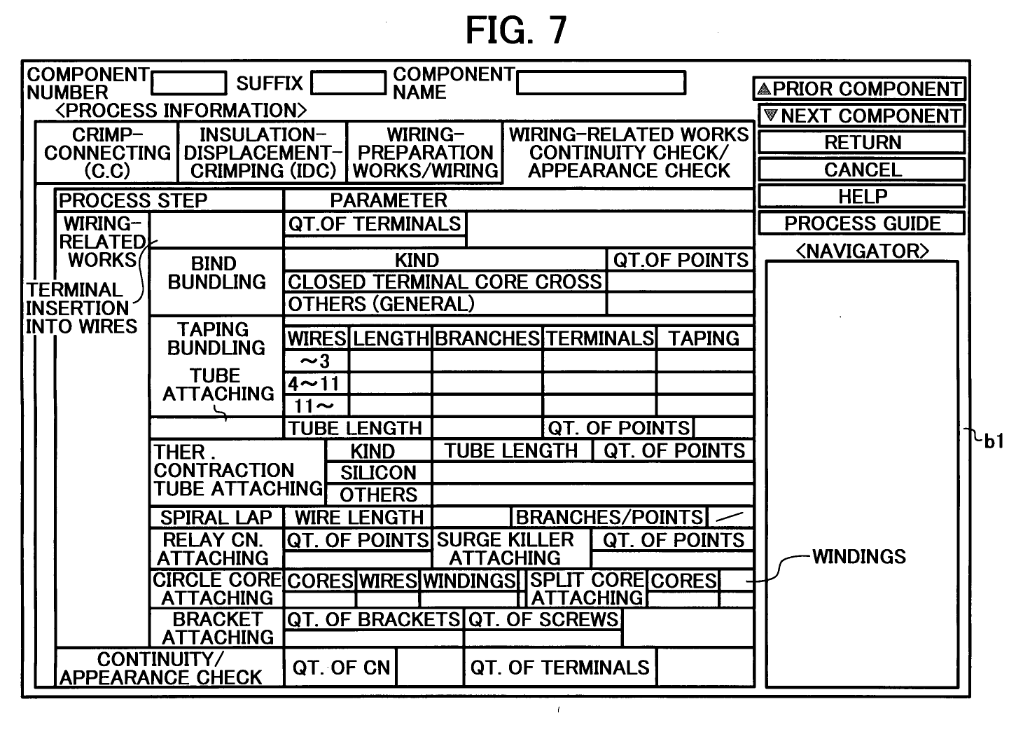

FIG. 7 shows a processing information screen for wiring-related works/continuity check/appearance check. In this processing information screen, input sections for inputting calculation factors necessary for calculating a processing cost required in the process step for wiring-related works/continuity check/appearance check are provided. The wiring-related works are classified into eleven categories, namely, terminal insertion into wires, bind bundling, taping bundling, tube attaching, thermal contraction tube attaching, spiral lap bundling, relay connector attaching, surge killer attaching, circle core attaching, split core attaching, and bracket attaching.

In the processing information screen for wiring-related works/continuity check/appearance check, an input section for inputting a quantity of terminals to be inserted is provided for terminal insertion into wires in wiring-related works. In this screen, input sections for inputting numbers of points for bind bundling in case of closed terminal/core cross fixing and in case of other methods than cross fixing, are provided for bind bundling in wiring-related works.

In the processing information screen for wiring-related works/continuity check/appearance check, input sections for inputting length of wire, number of branching points, quantity of closed terminals, and number of points for taping for respective “quantity of wires” categories are provided for taping bundling in wiring-related works. In this screen, input sections for inputting tube length and number of points for tube attaching are provided for tube attaching in wiring-related works. In this screen, input sections for inputting number of points for tube attaching and tube length in case of silicon tube and in case of other kinds of tubes than silicon tube are provided for thermal contraction tube attaching in wiring-related works. In this screen, input sections for inputting wire length, number of points for spiral lap bundling, and number of branching points are provided for spiral lap bundling in wiring-related works.

In the processing information screen for wiring-related works/continuity check/appearance check, an input section for inputting a quantity of relay connectors is provided for relay connector attaching in wiring-related works. In this screen, an input section for inputting a quantity of surge killers to be attached is provided for surge killer attaching in wiring-related works. In this screen, input sections for inputting a quantity of cores, a quantity of wires, and a number of times for winding are provided for circle core attaching in wiring-related works.

In the processing information screen for wiring-related works/continuity check/appearance check, input sections for inputting a quantity of cores, and a number of times for winding are provided for split core attaching in wiring-related works. In this screen, input sections for inputting a quantity of brackets and a quantity of screws are provided for bracket attaching in wiring-related works. In this screen, input sections for inputting a quantity of connectors and a quantity of terminals (limited to closed, circle, and faston terminals) are provided for continuity check. In this screen, input sections for inputting a quantity of connectors and a quantity of terminals (limited to closed, circle, and faston terminals) are provided for appearance check.

The navigator display section b1 is also provided in the right of the processing information screen for wiring-related works/continuity check/appearance check shown in FIG. 7.

The estimation requester inputs values in the input sections corresponding to the process step which is necessary for manufacturing a harness for which estimation is requested from a corresponding one of the above-explained processing information screens. When a “return” button in the upper right of each processing information screen is clicked, the processing information screen returns to the main screen. Then, by a calculating button a11 in the lowest row of the main screen being clicked, the unit component price of the harness for which estimation is requested is calculated.

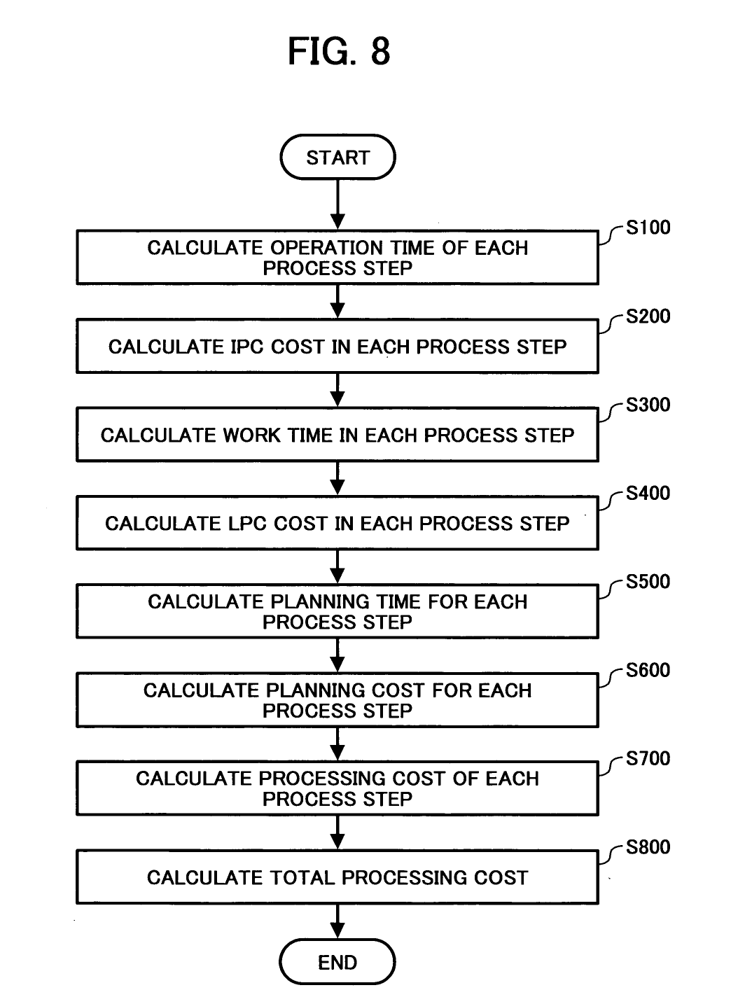

As described above, the unit component price of a harness is broken down into a material cost, a processing cost, a material loss cost, a material management cost, a general management cost, a profit margin, a transportation cost, and transportation/material handling cost. Estimation functions for individually calculating estimated costs for these costs are stored in the storage unit 41. Since an operation for calculating the processing cost, among these costs, is the feature of the present embodiment, the operation for calculating the processing cost will be explained first with reference to a flowchart shown in FIG. 8.

The estimation requester inputs processing conditions necessary for estimation from the main screen and the processing information screen, and clicks the calculating button all in the lowest row of the main screen. The click on the calculating button all triggers the control unit 44 to calculate the operation time in each process step (S100). This operation time is a time during which processing instruments are operated for processing the harness for which estimation is requested.

In each processing information screen, one can specify calculation factors for each process step such as fully-automated cutting, manual crimp-connecting, etc., as described above. On the other hand, the storage unit 41 stores operation time estimation functions for the respective process steps in the processing information screen. The control unit 44 inputs calculation factors input from the processing information screen into the corresponding operation time estimation function, and calculates the operation time for the corresponding process step. Or, the control unit 44 reads out an operation time corresponding to the input calculation factors from a predetermined table in the storage unit 41.

How to use the operation time estimation functions stored in the storage unit 41 in correspondence to the respective process steps explained in the processing information screen, and the table defining the operation times will now be explained.

[Operation Time Estimation Function for Insulation-Displacement-Crimping]

As shown in FIG. 3, process steps for insulation-displacement-crimping (IDC) includes semi-automated insulation-displacement-crimping, fully-automated insulation-displacement-crimping (simple), fully-automated insulation-displacement-crimping (multi), and fully-automated insulation-displacement-crimping (copper foil shield).

The control unit 44 calculates the operation time for semi-automated insulation-displacement-crimping by using an operation time estimation function indicated by an equation (1) below.

Operation Time=3.1×number of times for carrying out IDC+1.7×quantity of wires+1.0×number of kinds of connectors (1)

Values input in the input sections in the “semi-automated insulation-displacement-crimping” category in the processing information screen shown in FIG. 3 are used as the number of times for carrying out IDC, quantity of wires, and number of kinds of connectors in the above estimation function.

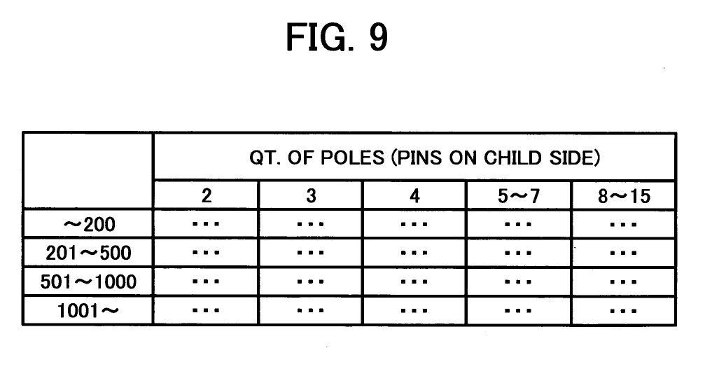

The operation time of the fully-automated insulation-displacement-crimping (simple) can be acquired an operation time table shown in FIG. 9. This operation time table is pre-stored in the storage unit 41. The operation time table shown in FIG. 9 defines operation times corresponding to the values for the respective “wire's largest length” categories and the respective “quantity of poles” categories input in the input sections in the “fully-automated insulation-displacement-crimping (simple)” category.

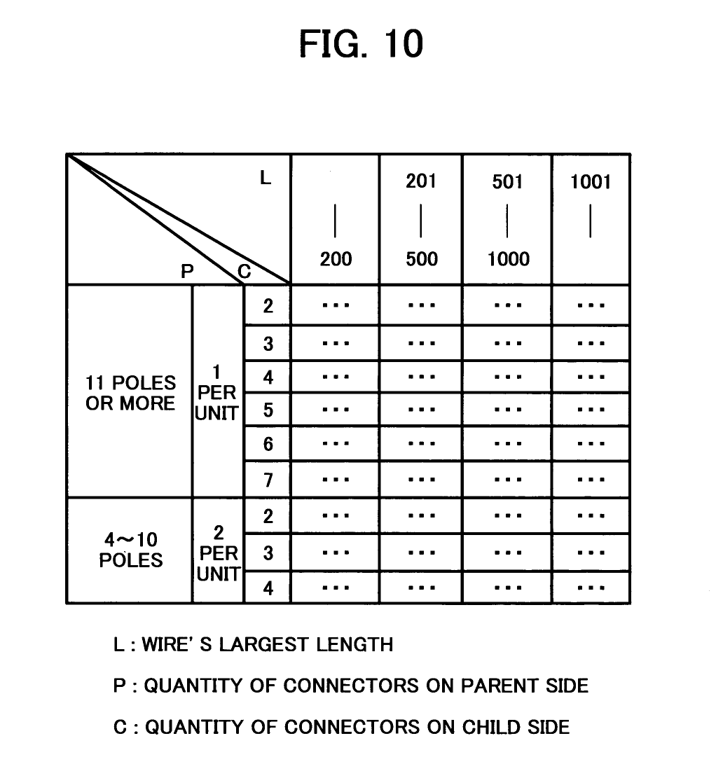

The control unit 44 acquires the operation time for fully-automated insulation-displacement-crimping (multi) from an operation time table shown in FIG. 10. This operation time table is pre-stored in the storage unit 41. The operation time table shown in FIG. 10 defines operation times corresponding to the values for the respective “wire's largest length” categories and respective “quantity of poles” categories input in the input sections in the “fully-automated insulation-displacement-crimping (multi)” category.

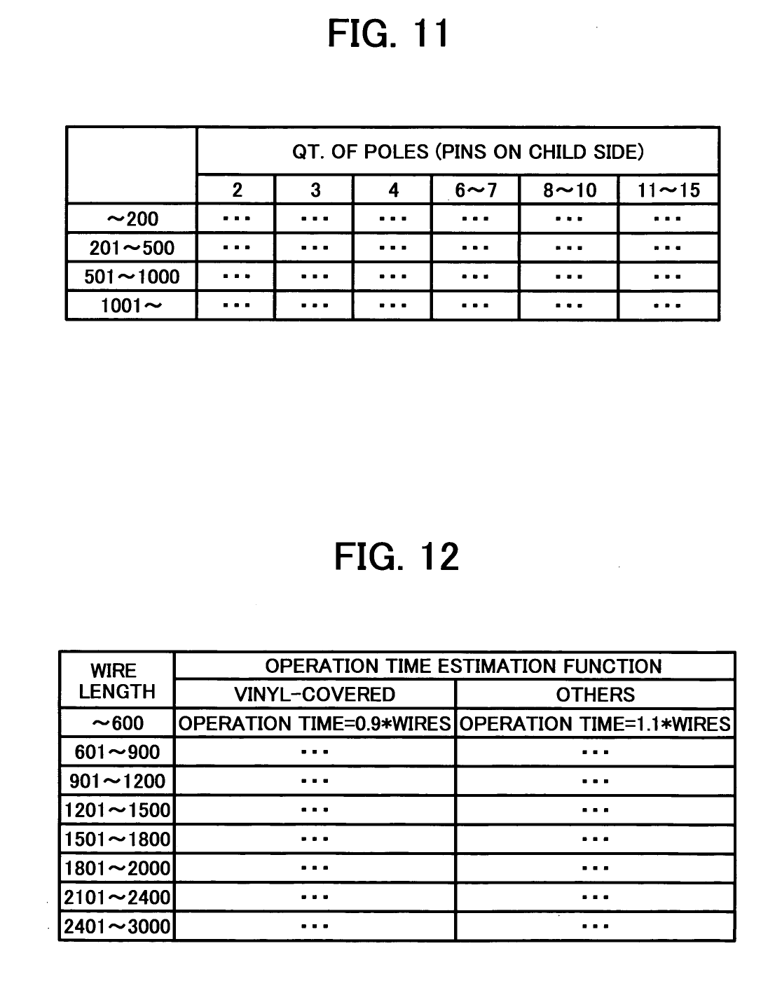

The control unit 44 acquires the operation time for fully-automated insulation-displacement-crimping (copper foil shield) from an operation time table shown in FIG. 11. This operation time table is pre-stored in the storage unit 41. The operation time table shown in FIG. 11 defines operation times corresponding to the values for the respective “wire's largest length” categories and the respective “quantity of poles” categories input in the input sections in the “fully-automate insulation-displacement-crimping (copper foil shield)” category.

[Operation Time Estimation Function for Crimp-Connecting]

As shown in FIG. 5, the process steps for crimp-connecting include fully-automated cutting, manual crimp-connecting (closed terminal), separate terminal crimp-connecting (resin-covered circle terminal), continuous-terminal crimp-connecting, fully-automated dual terminal crimp-connecting, and terminal inserting.

The control unit 44 calculates the operation time for fully-automated cutting by using an operation time estimation function read out from a calculation equation table shown in FIG. 12. The calculation equation table is pre-stored in the storage unit 41. The calculation equation table shown in FIG. 12 defines operation time estimation functions for the respective “wire length” categories and the respective “kinds of quantities of wires” categories shown in FIG. 5. The operation time is calculated by inputting a value in the input section for “quantity of wires” in FIG. 5 into an operation time estimation function defined in the calculation equation table shown in FIG. 12. Accordingly, the control unit 44 obtains values by inputting quantities of wires into the respective operation time estimation functions read out from the calculation equation table shown in FIG. 12, and calculates the operation time by adding up the obtained values.

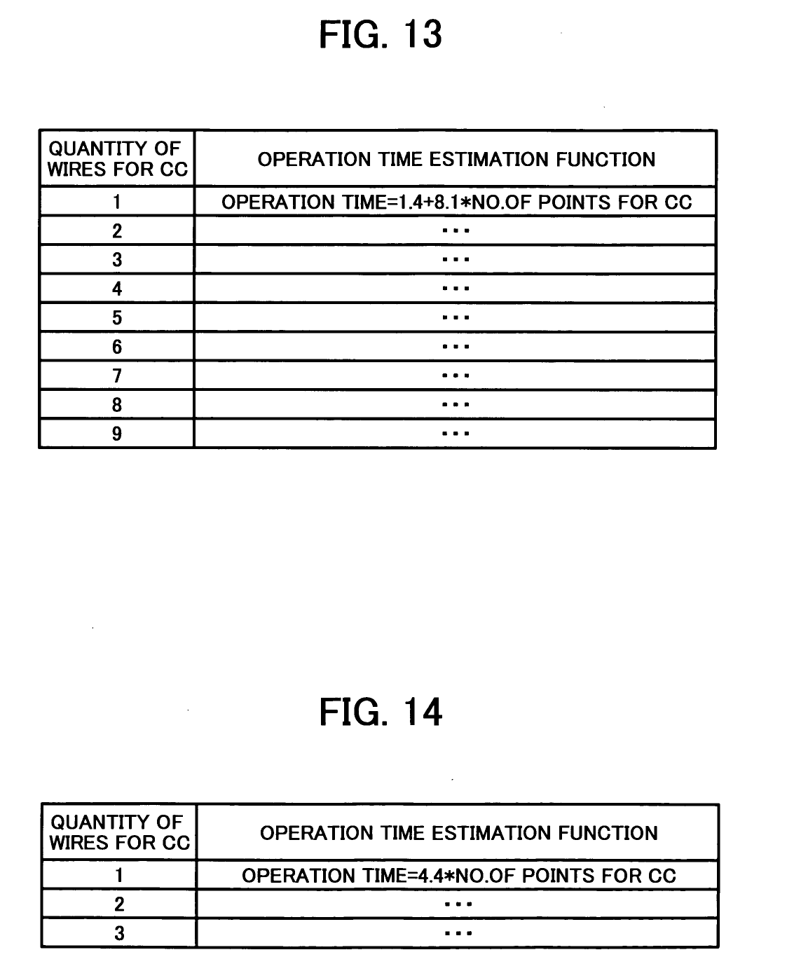

The control unit 44 calculates the operation time for manual crimp-connecting (closed terminal) by using an operation time estimation function read out from a calculation equation table shown in FIG. 13. The calculation equation table is pre-stored in the storage unit 41. The calculation equation table shown in FIG. 13 defines operation time estimation functions for the respective “quantity of wires for crimp-connecting” categories shown in FIG. 5. The operation time is calculated by inputting a value in the input section for “number of points” in FIG. 5 into an operation time estimation function defined in the calculation equation table shown in FIG. 13.

Accordingly, the control unit 44 obtains values by inputting numbers of points to which manual crimp-connecting is applied into the respective operation time estimation functions read out form the calculation equation table shown in FIG. 13, and calculates the operation time by adding up the obtained values.

The control unit 44 calculates the operation time for separate terminal crimp-connecting (resin-covered circle terminal) by using an operation time estimation function read out from a calculation equation table shown in FIG. 14. This calculation equation table is pre-stored in the storage unit 41. The calculation equation table shown in FIG. 14 defines operation time estimation functions for the respective “quantity of wires for crimp-connecting” categories shown in FIG. 5.

The operation time is calculated by inputting a value in the input section for “number of points” in FIG. 5 into an operation time estimation function defined in the calculation equation table shown in FIG. 14. Accordingly, the control unit 44 obtains values by inputting numbers of points to which separate terminal crimp-connecting is applied into the respective operation time estimation functions read out from the calculation equation table shown in FIG. 14, and calculates the operation time by adding up the obtained values.

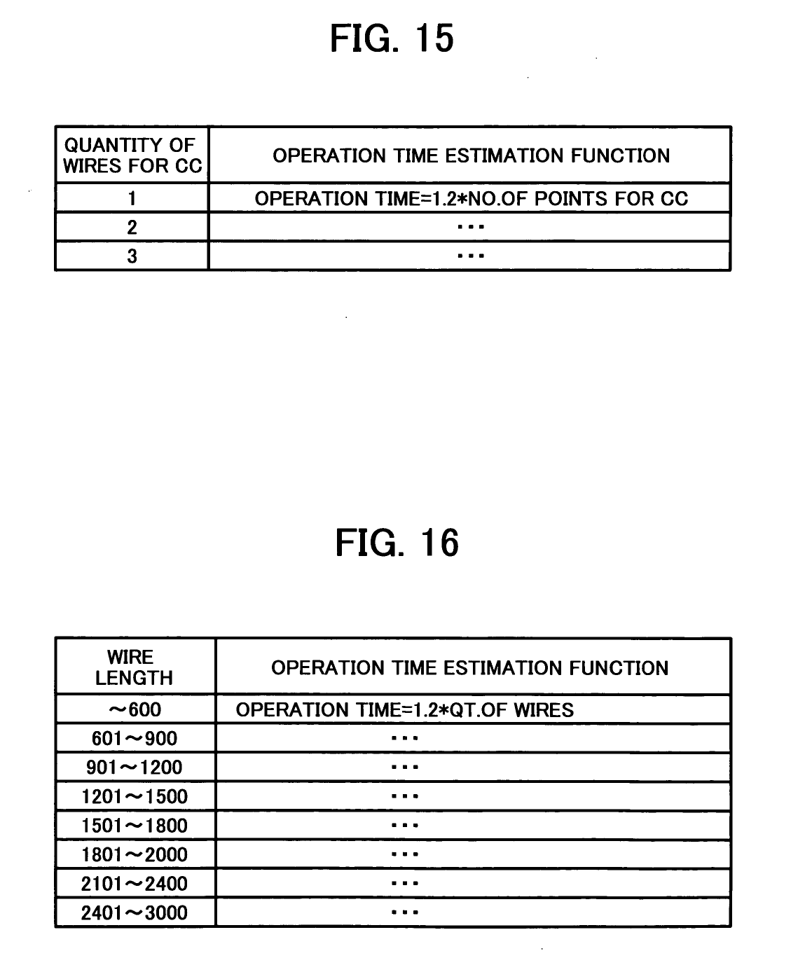

The control unit 44 calculates the operation time for continuous terminal crimp-connecting by using an operation time estimation function read out from a calculation equation table shown in FIG. 15. The calculation equation table is stored in the storage unit 41. The calculation equation table shown in FIG. 15 defines operation time estimation functions for the respective “quantity of wires for crimp-connecting” categories shown in FIG. 5.

The operation time is calculated by inputting a value in the input section for “number of points” in FIG. 5 into an operation time estimation function defined in the calculation equation table shown in FIG. 15. Accordingly, the control unit 44 obtains values by inputting numbers of points to which continuous terminal crimp-connecting is applied into the respective operation time estimation functions read out from the calculation equation table shown in FIG. 15, and calculates the operation time by adding up the obtained values.

The control unit 44 calculates the operation time for fully-automated dual terminal crimp-connecting by using an operation time estimation function read out from a calculation equation table shown in FIG. 16. The calculation equation table is pre-stored in the storage unit 41. The calculation equation table shown in FIG. 16 defines operation time estimation functions for the respective “wire length” categories shown in FIG. 5. The operation time is calculated by inputting a value in the input section for “quantity of wires” in FIG. 5 into an operation time estimation function defined in the calculation equation table shown in FIG. 16. Accordingly, the control unit 44 obtains values by inputting quantities of wires in the respective operation time estimation functions read out from the calculation equation table shown in FIG. 16, and calculates the operation time by adding up the obtained values.

The control unit 44 calculates the operation time for terminal inserting by using an estimation function indicated by an equation (2) below.

Operation Time=2.9×quantity of connectors+2.5×quantity of terminals (2)

The control unit 44 uses values input in the input sections for the “terminal inserting” category in FIG. 5, as quantity of connectors and quantity of terminals in the above estimation function (2).

[Operation Time Estimation Function for Wiring Preparation Works/Wiring]

As shown in FIG. 6, the process steps for wiring preparation works/wiring includes soldering, insulation sleeve insertion, wire mark adhering, single CN insertion into housing, and wiring.

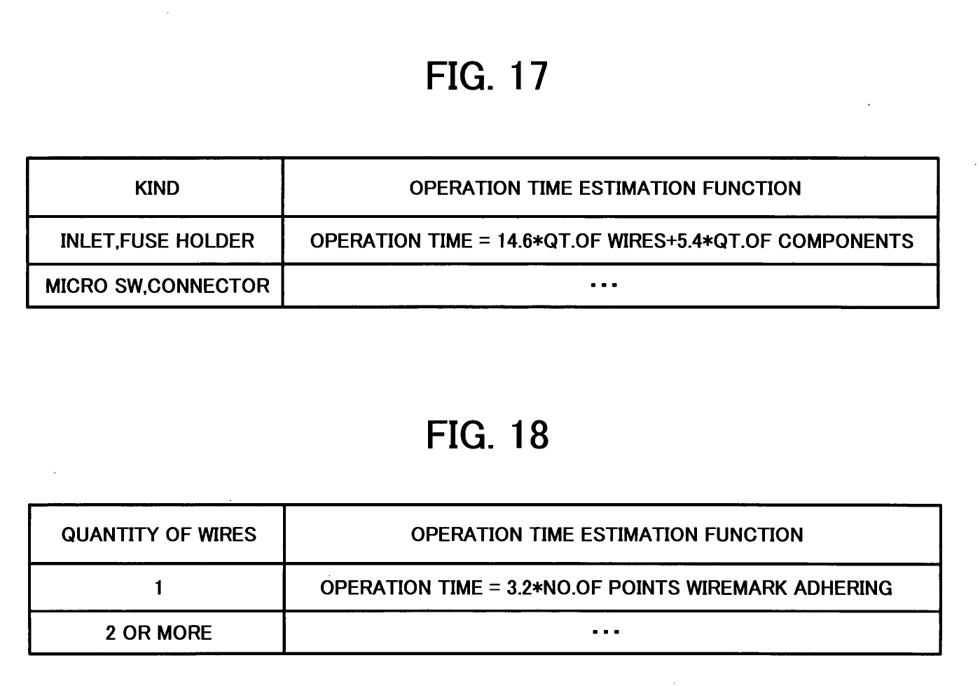

The control unit 44 calculates the operation time for soldering in the wiring preparation works by using an operation time estimation function read out from a calculation equation table shown in FIG. 17. The calculation equation table is pre-stored in the storage unit 41. The calculation equation table shown in FIG. 17 defines operation time estimation functions for the respective kinds of works (inlet fuse, micro SW, connector) shown in FIG. 6. The operation time is calculated by inputting values in the input sections for “quantity of wires” and “quantity of components” in FIG. 6 into an operation time estimation function defined in the calculation equation table shown in FIG. 17.

Accordingly, the control unit 44 obtains values by inputting quantities of wires and quantities of components to which soldering is applied into the respective operation time estimation functions read out from the calculation equation table shown in FIG. 17, and calculates the operation time by adding up the obtained values.

The control unit 44 calculates the operation time for insulation sleeve insertion in the wiring preparation works by using an operation time estimation function indicated by an equation (3) below.

Operation Time=90×number of points to which sleeve is inserted (3)

The control unit 44 uses a value input in the input section for “number of points for insulation sleeve insertion” in FIG. 6, as number of points to which a sleeve is inserted in the above equation (3).

The control unit 44 calculates the operation time for wire mark adhering in the wiring preparation works by using an operation time estimation function read out from a calculation equation table shown in FIG. 18. The calculation equation table is pre-stored in the storage unit 41. The calculation equation table shown in FIG. 18 defines operation time estimation functions for the respective “quantity of wires” categories (1, and 2 or more) shown in FIG. 6.

The operation time is calculated by inputting a value in the input section for “number of points to which a wire mark is adhered” in FIG. 6 into an operation time estimation function defined in the calculation equation table shown in FIG. 18. Accordingly, the control unit 44 obtains values by inputting numbers of points to which a wire mark is adhered into the respective operation time estimation functions read out from the calculation equation table shown in FIG. 18, and calculates the operation time by adding up the obtained values.

The control unit 44 calculates the operation time for single CN insertion into housing in the wiring preparation works by using an estimation function indicated by an equation (4) below.

Operation Time=1.0+9.0×quantity of housings (4)

A value input in the input section for “quantity of housings” in FIG. 6 is used as quantity of housings in the above equation (4).

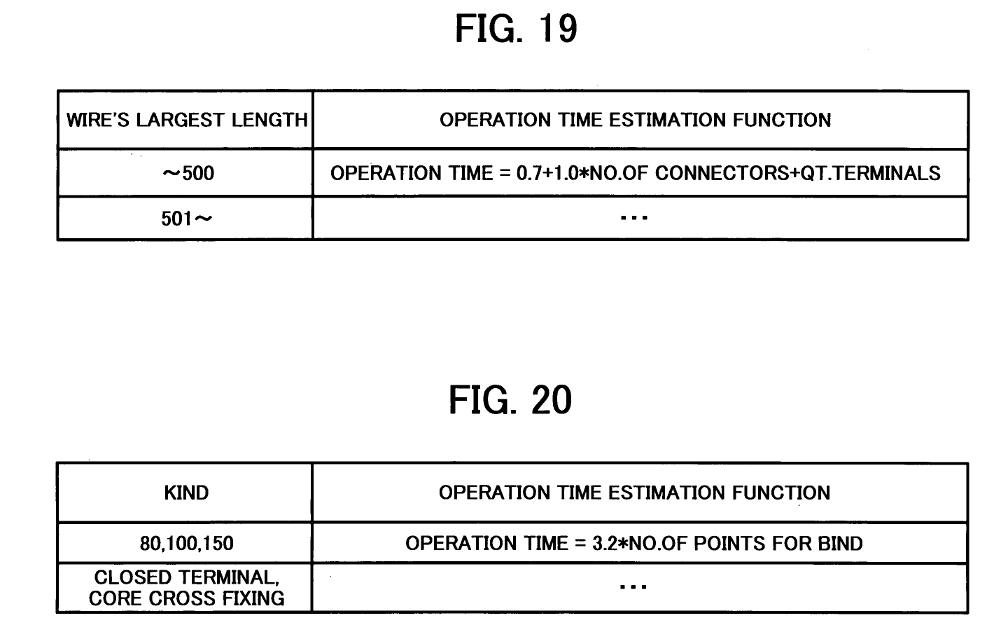

The control unit 44 calculates the operation time for wiring by using an operation time estimation function read out from a calculation equation table shown in FIG. 19. The calculation equation table is pre-stored in the storage unit 41. The calculation equation table shown in FIG. 19 defines operation time estimation functions for the respective “wire's largest length” categories shown in FIG. 6. The operation time is calculated by inputting values in the input sections for “quantity of connectors” and “quantity of terminals” in FIG. 6 into an operation time estimation function defined in the calculation equation table shown in FIG. 19. Accordingly, the control unit 44 calculates the operation time for wiring by inputting quantities of connectors and quantities of terminals into the respective operation time estimation functions read out from the calculation equation table shown in FIG. 19.

[Operation Time Estimation Function for Wiring-Related Works/Continuity Check/Appearance Check]

As shown in FIG. 7, the process steps for wiring-related works/continuity check/appearance check include terminal insertion into wires, bind bundling, taping bundling, tube attaching, thermal contraction tube attaching, spiral lap bundling, relay connector attaching, surge killer attaching, circle core attaching, split core attaching, bracket core attaching, and continuity check and appearance check.

The control unit 44 calculates the operation time for terminal insertion into wires by using an estimation function indicated by an equation (5) below.

Operation Time=2.9+3.9×quantity of terminal to be inserted (5)

A value input in the input section for “quantity of terminals to be inserted” in FIG. 7 is used as quantity of terminals to be inserted in the estimation function indicated by the equation (5).

The control unit 44 calculates the operation time for bind bundling by using an operation time estimation function read out from a calculation equation table shown in FIG. 20. This calculation equation table is pre-stored in the storage unit 41. The calculation equation table 20 defines operation time estimation functions for the respective “kind of bind” categories (80, 100, 150, closed terminal, core cross fixing) shown in FIG. 7. The operation time is calculated by inputting a value in the input section for “number of points for bind” in FIG. 7 into an operation time estimation function defined in the calculation equation table shown in FIG. 20.

Accordingly, the control unit 44 calculates the operation time for bind bundling by inputting numbers of points for bind into the respective operation time estimation functions read out from the calculation equation table shown in FIG. 20.

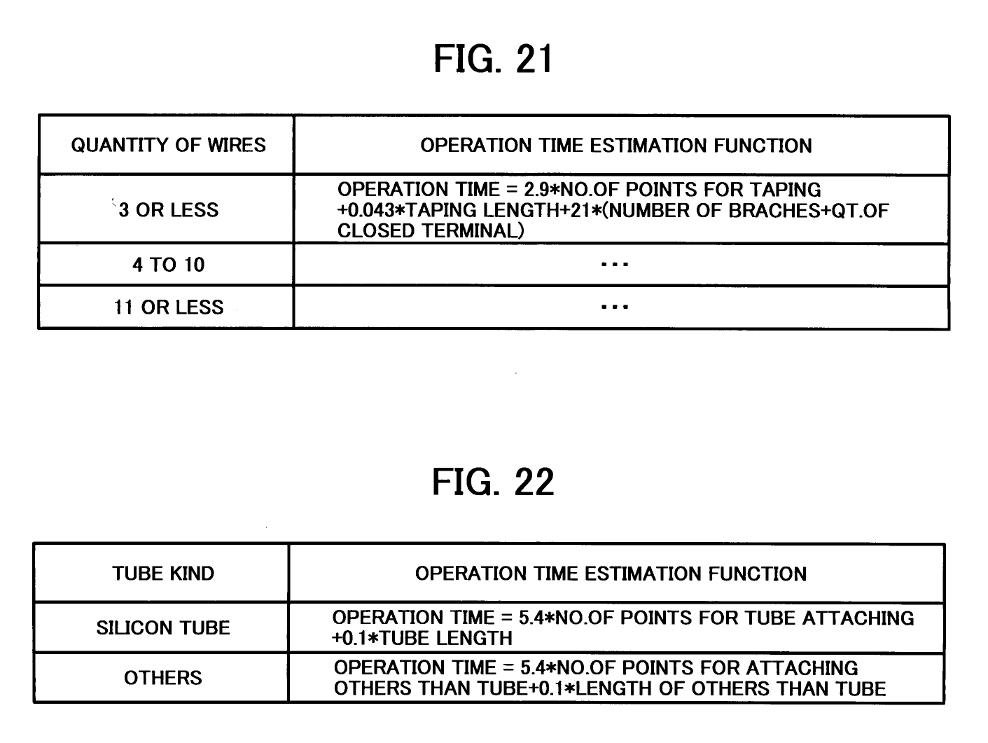

The control unit 44 calculates the operation time for taping bundling by using an operation time estimation function read out from a calculation equation table shown in FIG. 21. The calculation equation table is pre-stored in the storage unit 41. The calculation equation table shown in FIG. 21 defines operation time estimation functions for the respective “quantity of wires” categories (3 or less, 4 to 10, 11 or less) shown in FIG. 7.

The operation time is calculated by inputting values in the input sections for “length”, “number of branching points”, “quantity of closed terminals”, and “number of points for taping” into an operation time estimation function defined in the calculation equation table shown in FIG. 21. Accordingly, the control unit 44 calculates the operation time for taping bundling by inputting lengths, numbers of branching points, quantities of closed terminals, and numbers of points for taping into the respective operation time estimation functions read out from the calculation equation table shown in FIG. 21.

The control unit 44 calculates the operation time for tube attaching by using an estimation function indicated by an equation (6) below.

Operation Time=0.7+6.5×number of points for attaching a tube+0.01×tube length (6)

A value input in the input section for “number of points” to which a tube is attached in FIG. 7 is used as number of points for attaching a tube in the estimation function indicated by the equation (6). A value input in the input section for “tube length” in FIG. 7 is used as tube length in the above estimation function.

The control unit 44 calculates the operation time for thermal contraction tube attaching by using an operation time estimation function read out from a calculation equation table shown in FIG. 22. The calculation equation table is pre-stored in the storage unit 41. The calculation equation table shown in FIG. 22 defines operation time estimation functions for the respective “tube kind” categories (silicon tube and other kinds of tubes) shown in FIG. 7. The operation time is calculated by inputting values in the input sections for “number of points” and “tube length” in FIG. 7 into an operation time estimation function defined in the calculation equation table shown in FIG. 22. Accordingly, the control unit 44 calculates the operation time by inputting numbers of points and tube lengths into the respective operation time estimation functions read out from the calculation equation table shown in FIG. 22.

The control unit 44 calculates the operation time for spiral lap bundling by using an operation time estimation function indicated by an equation (7) below.

Operation Time=0.3+1.0×number of points for spiral lap bundling+0.3×wire length+3.6×number of branching points (7)

A value input in the input section for “number of points” to which spiral lap bundling is applied in FIG. 7 is used as number of points for spiral lap bundling in the above estimation function indicated by the equation (7). A value input in the input section for “wire length” in FIG. 7 is used as wire length in the above estimation function. A value input in the input section for “number of branching points” in FIG. 7 is used as number of branching points in the above estimation function.

The control unit 44 calculates the operation time for relay connector attaching by using an estimation function indicated by an equation (8) below.

Operation Time=1.0+1.8×quantity of relay connectors (8)

A value input in the input section for “quantity” of relay connectors in FIG. 7 is used as quantity of relay connectors in the equation (8).

The control unit 44 calculates the operation time for surge killer attaching by using an estimation function indicated by an equation (9) below.

Operation Time=1.0+21.5×quantity of surge killers (9)

A value input in the input section for “quantity” of surge killers in FIG. 7 is used as quantity of surge killers in the equation (9).

The control unit 44 calculates the operation time for circle core attaching by using an estimation function indicated by an equation (10) below.

Operation Time=0.3+1.0×quantity of wires+3.6×number of times for winding+1.0×quantity of cores (10)

A value input in the input section for “quantity of wires” in FIG. 7 is used as quantity of wires in the equation (10). A value input in the input section for “number of times for winding” in FIG. 7 is used as number of time for winding in the equation (10). A value input in the input section for “quantity of cores” in FIG. 7 is used as number of cores in the equation (10).

The control unit 44 calculates the operation time for split core attaching by using an estimation function indicated by an equation (11) below.

Operation Time=1.0+1.8×quantity of cores+1.8×number of times for winding (11)

A value input in the input section for “quantity of cores” in FIG. 7 is used as quantity of cores in the equation (11). A value input in the input section for “number of times for winding” in FIG. 7 is used as number of times for winding in the equation (11).

The control unit 44 calculates the operation time for bracket attaching by using an estimation function indicated by an equation (12) below.

Operation Time=1.0+8.7×quantity of brackets+8.7×quantity of screws (12)

A value input in the input section for “quantity of brackets” in FIG. 7 is used as quantity of brackets in the equation (12). A value input in the input section for “quantity of screws” in FIG. 7 is used as quantity of screws in the equation (12).

The control unit 44 calculates the operation time for continuity check by using an estimation function indicated by an equation (13) below.

Operation Time=3.2+3.2×(quantity of connectors+quantity of terminals) (13)

A value input in the input section for “quantity of connectors” in FIG. 7 is used as quantity of connectors in the equation (13). A value in the input section for “quantity of terminals” in FIG. 7 is used as quantity of terminals in the equation (13).

The control unit 44 calculates the operation time for appearance check by using an estimation function indicated by an equation (14) below.

Operation Time=1.5×(quantity of connectors+quantity of terminals) (14)

A value input in the input section for “quantity of connectors” in FIG. 7 is used as quantity of connectors in the equation (14). A value input in the input section for “quantity of terminals” in FIG. 7 is used as quantity of terminals in the equation (14).

Explanation will now return to FIG. 8.

The control unit 44, which has calculated the operation time of each process step (S100), then calculates an instrument-proportional common cost (IPC cost) in each process step (S200). The instrument-proportional common cost is a material cost arising from operation of harness processing instruments. The control unit 44 calculates the instrument-proportional common cost by using an operation cost estimation function indicated by an equation (15) below.

IPC cost=net operation time×time factor×IPC cost ratio (15)

This operation cost estimation function indicated by the equation (15) will now be explained in more detail. The operation time is the operation time calculated for each process step. The time factor is acquired from a time factor setting table which is pre-stored in the storage unit 41.

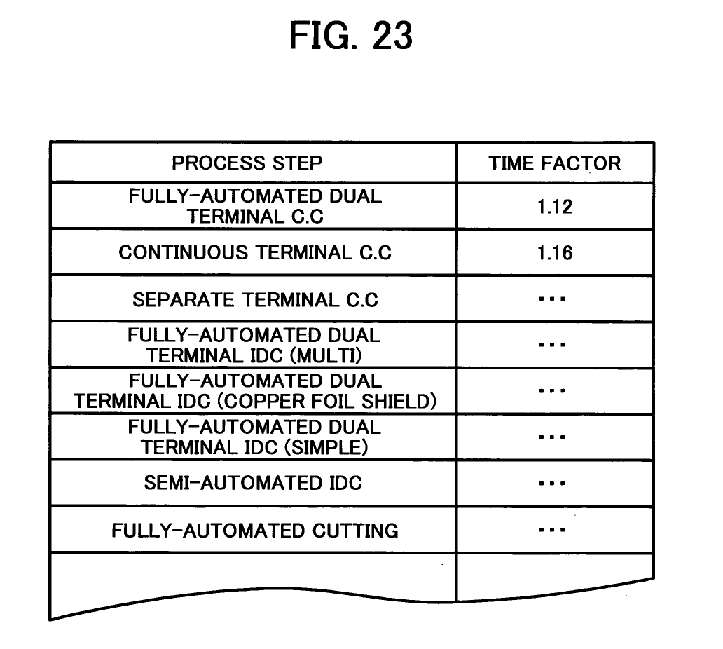

FIG. 23 shows the contents of the time factor setting table. The time factor setting table associates the process steps shown in FIG. 3, FIG. 5, FIG. 6 and FIG. 7 with corresponding time factors. The instrument-proportional common cost ratio (IPC cost ratio) is acquired from a processing cost ratio master table which is pre-stored in the storage unit 41.

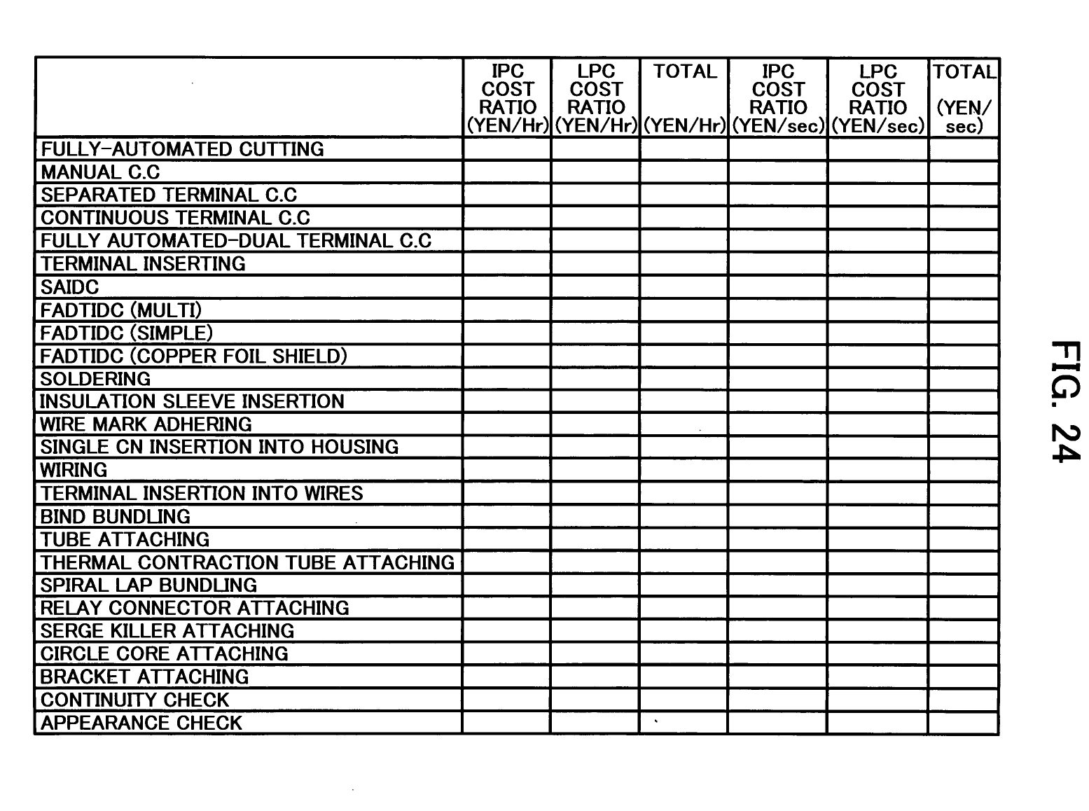

FIG. 24 shows the contents of the processing cost ratio master table. The processing cost ratio master table associates the process steps shown in FIG. 3, FIG. 5, FIG. 6, and FIG. 7 with corresponding instrument-proportional common cost ratios and corresponding labor-proportional common cost ratios (LPC cost ratios). The instrument-proportional common cost ratio is a ratio of a cost commonly required in proportion to the kinds of instruments. The labor-proportional common cost ratio is a ratio of a cost commonly required in proportion to the kinds of labors.

Accordingly, the control unit 44 calculates the instrument-proportional common cost for each process step by inputting the calculated operation time, a time factor read out from the time factor setting table, and an instrument-proportional common cost ratio read out from the processing cost ratio master table shown in FIG. 24 into the operation cost estimation function read out from the storage unit 41.

In addition to the instrument-proportional common cost ratio per hour and the labor-proportional common cost ratio per hour, the processing cost ratio master table shown in FIG. 24 defines ratios obtained by converting these ratios into ratios per second. The control unit 44 makes calculations by using the instrument-proportional common cost ratio per second and the labor-proportional common cost ratio per second.

The control unit 44, which has calculated the instrument-proportional common cost, calculates a work time in each process step (S300). The work time is calculated by using a work time estimation function indicated by an equation (16) below.

Work Time=Operation time/number of working members (16)

This work time estimation function will now be explained in more detail.

The operation time is the operation time calculated for each process step. The number of working members is the number of harness processing instruments handled by one working member, and is pre-set for each process step. For example, the number of working members is set to 2 for fully-automated dual terminal crimp-connecting, 1.5 for fully-automated dual terminal insulation-displacement-crimping (FADTIDC), and 1 for the rest of the process steps. This means that two fully-automated dual terminal crimp-connecting (FADTCC) machines should be handled by one member, and three fully-automated dual terminal insulation-displacement-crimping (FADTIDC) machines should be handled by two members.

The control unit 44, which has calculated the work time, calculates a labor-proportional common cost (LPC cost) for each process step (S400). The labor-proportional common cost is a labor cost arising from operation of harness processing instruments. The control unit 44 calculates the labor-proportional common cost by using an operation cost estimation function indicated by an equation (17) below.

LPC cost=net work time×time factor×LPC cost ratio (17)

The operation cost estimation function (labor-proportional common cost estimation function) will now be explained in more detail. The work time is the work time calculated for each process step. The time factor is acquired from the time factor setting table shown in FIG. 23. The labor-proportional common cost ratio is acquired from the processing cost ratio master table shown in FIG. 24.

The control unit 44, which has calculated the labor-proportional common cost, calculates a planning time for each process step (S500). As described above, calculation factors for each process step such as fully-automated cutting and manual crimp-connecting, etc. are input from the processing information screen.

On the other hand, the storage unit 41 stores planning time estimation functions for the respective process steps in the processing information screen. The control unit 44 reads out a planning time estimation function for a process step for which calculation factors are input from the processing information screen, from the storage unit 41. The control unit 44 inputs the input calculation factors and calculation factors read out from a predetermined table in the storage unit 41 into the planning time estimation function, and calculates the planning time for the process step.

However, note that some process steps do not need a planning work. The control unit 44 sets the planning time for process steps that do not need a planning work, as 0.

The specific content of the planning time estimation function stored in the storage unit 41 in association with each process step shown in the processing information screen will now be explained.

[Planning Time Estimation Function for Insulation-Displacement-Crimping]

As shown in FIG. 3, the process steps relating to insulation-displacement-crimping include semi-automated insulation-displacement-crimping, fully-automated insulation-displacement-crimping (simple), fully-automated insulation-displacement-crimping (multi), and fully-automated insulation-displacement-crimping (copper foil shield).

The control unit 44 calculates the planning time for semi-automated insulation-displacement-crimping by using a planning time estimation function indicated by an equation (18) below.

Planning Time=90×number of kinds of connectors (18)

A value input in the input section for “number of kinds of connectors” in FIG. 3 is used as number of kinds of connectors in the above equation (18).

The control unit 44 calculates the planning time for fully-automated insulation-displacement-crimping (simple) by using a planning time estimation function indicated by an equation (19) below.

Planning Time=35×number of kinds of wire lengths (19)

Number of kinds of wire lengths in the above equation (19) is the total number of categories in which quantity of poles is input, among the four categories of “wire's largest length” shown in FIG. 3.

The control unit 44 calculates the planning time for fully-automated insulation-displacement-crimping (multi) by using a planning time estimation function indicated by an equation (20) below.

Planning Time=50×number of kinds of wire lengths (20)

Number of kinds of wire lengths in the above equation (20) is the total number of categories in which quantity of poles is input, among the four categories of “wire's largest length” shown in FIG. 3.

The control unit 44 calculates the planning time for fully-automated insulation-displacement-crimping (copper foil shield) by using a planning time estimation function indicated by an equation (21) below.

Planning Time=40×number of kinds of wire lengths (21)

Number of kinds of wire lengths in the above equation (21) is the total number of categories in which quantity of poles is input, among the four categories of wire's largest length shown in FIG. 3.

[Planning Time Estimation Function for Crimp-Connecting]

As shown in FIG. 5, the process steps relating to crimp-connecting include fully-automated cutting, manual crimp-connecting (closed terminal), separate terminal crimp-connecting (resin-covered circle terminal), continuous terminal crimp-connecting, fully-automated dual terminal crimp-connecting, and terminal inserting.

The control terminal 4 calculates the planning time for fully-automated cutting by using a planning time estimation function indicated by an equation (22) below.

Planning Time=30×number of kinds of wire lengths (22)

A value input in the input section for “number of kinds of wire lengths” in FIG. 5 is used as number of kinds of wire lengths in the above equation (22). Since the process step for manual crimp-connecting does not need a planning work, the control unit 44 sets the planning time for this process step as 0.

The control unit 44 calculates the planning time for separate terminal crimp-connecting (resin-covered circle terminal) by using a planning time estimation function indicated by an equation (23) below.

Planning Time=60×number of kinds of terminals (23)

A value input in the input section for “number of kinds of terminals” in FIG. 5 is used as number of kinds of terminals in the above equation (23).

The control unit 44 calculates the planning time for continuous terminal crimp-connecting by using a planning time estimation function indicated by an equation (24) below.

Planning Time=55×number of kinds of terminals (24)

A value input in the input section for “number of kinds of terminals” in FIG. 5 is used as number of kinds of terminals in the above equation (24).

The control unit 44 calculates the planning time for fully-automated dual terminal crimp-connecting by using a planning time estimation function indicated by an equation (25) below.

Planning Time=70×number of kinds of wire lengths (25)

A value input in the input section for “number of kinds of wire lengths” in FIG. 5 is used as number of kinds of wire lengths in the above equation (25).

Since the process step for terminal inserting does not need a planning work, the control unit 44 sets the planning time for this process step as 0.

[Planning Time Estimation Function for Wiring Preparation Works/Wiring]

As shown in FIG. 6, the process steps relating to wiring preparation works/wiring include soldering, insulation sleeve insertion, wire mark adhering, single CN insertion into housing, and wiring. Since all of these process steps do not need a planning work, the control unit 44 sets the planning time for these process steps as 0.

[Planning Time Estimation Function for Wiring-Related Works/Continuity Check/Appearance Check]

As shown in FIG. 7, the process steps relating to wiring-related works/continuity check/appearance check include terminal insertion into wires, bind bundling, taping bundling, tube attaching, thermal contraction tube attaching, spiral lap bundling, relay connector attaching, surge killer attaching, circle core attaching, split core attaching, bracket attaching, and continuity check and appearance check. Since all of these process steps do not need a planning work, the control unit 44 sets the planning time for these process steps as 0.

Explanation will now return to FIG. 8.

The control unit 44, which has calculated the planning time, calculates a planning cost for each process step (S600).

The planning cost includes a material cost and a labor cost arising in the preparation stage before operating harness processing instruments. The control unit 44 calculates the planning cost by using a planning cost estimation function indicated by an equation (26) below.

Planning Cost=(net planning time/working lot)×time factor×(IPC cost ratio+LPC cost ratio) (26)

This planning cost estimation function will now be explained more specifically. Planning time in the equation (26) is the planning time calculated for each process step. Time factor is pre-set to 1.13. IPC cost ratio and LPC cost ratio are acquired from the processing cost ratio master table shown in FIG. 24.

The control unit 44, which has calculated the planning cost, calculates the processing cost for each process step by adding up the instrument-proportional common cost, the labor-proportional common cost, and the planning cost of each process step which have been calculated (step S700). The processing cost of each process step is displayed on a later-described processing cost display screen.

Further, the control unit 44 calculates the total of the processing costs by adding up the processing costs of all of the process steps (step S800). This total processing cost is displayed on a later-described unit component price screen and on the processing cost display screen.

Thus, the calculation of the processing cost shown in FIG. 8 is completed.

The control unit 44 calculates the other costs such as the material cost, the material loss cost, the material management cost, the general management cost, the profit margin, and the transportation/material handling cost, by using estimation functions read out from the storage unit 41, likewise the processing cost explained above. A detailed explanation of how to calculate these costs will be omitted.

When the estimation requester clicks an estimation result list display button a8 in the main screen shown in FIG. 2, the control unit 44 displays the calculation results on the output unit 43, as an estimated cost list screen.

The estimated cost list screen is constituted by a unit component price screen displaying the unit component price, and its breakdown including the material cost, the processing cost, the material loss cost, the material management cost, the general management cost, the profit margin, and the transportation/material handling cost, and by a processing cost display screen displaying the processing cost of each process step.

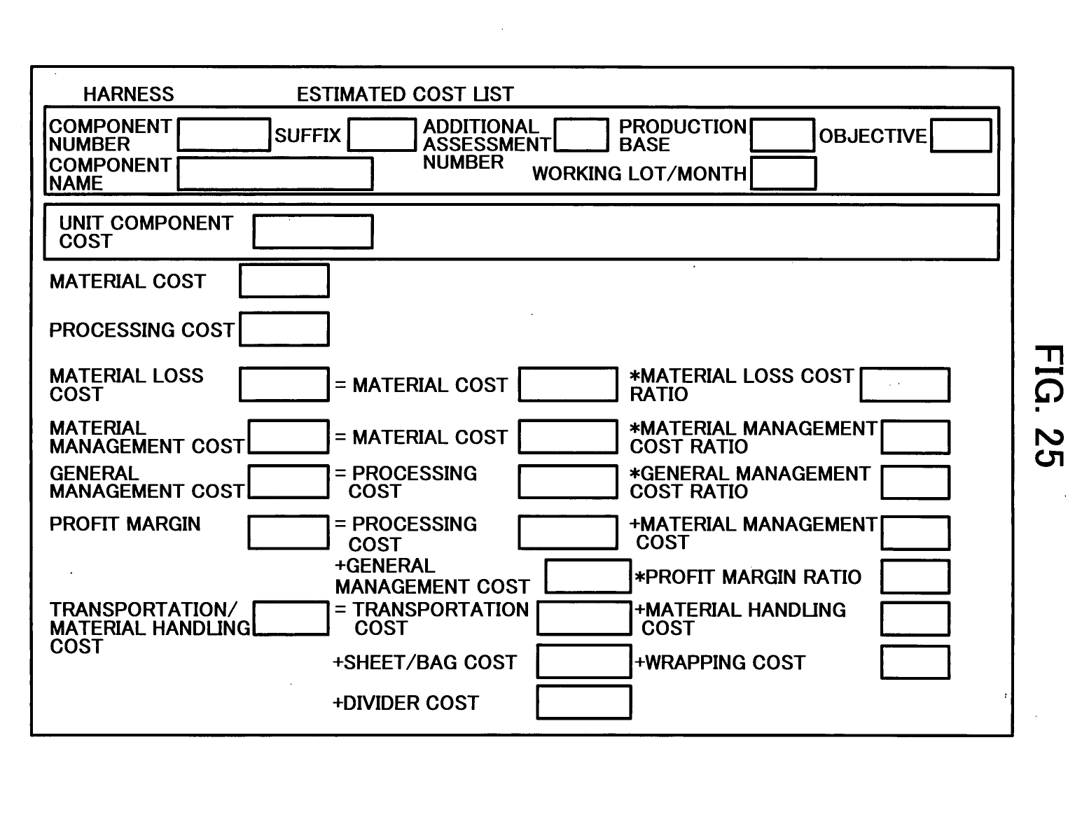

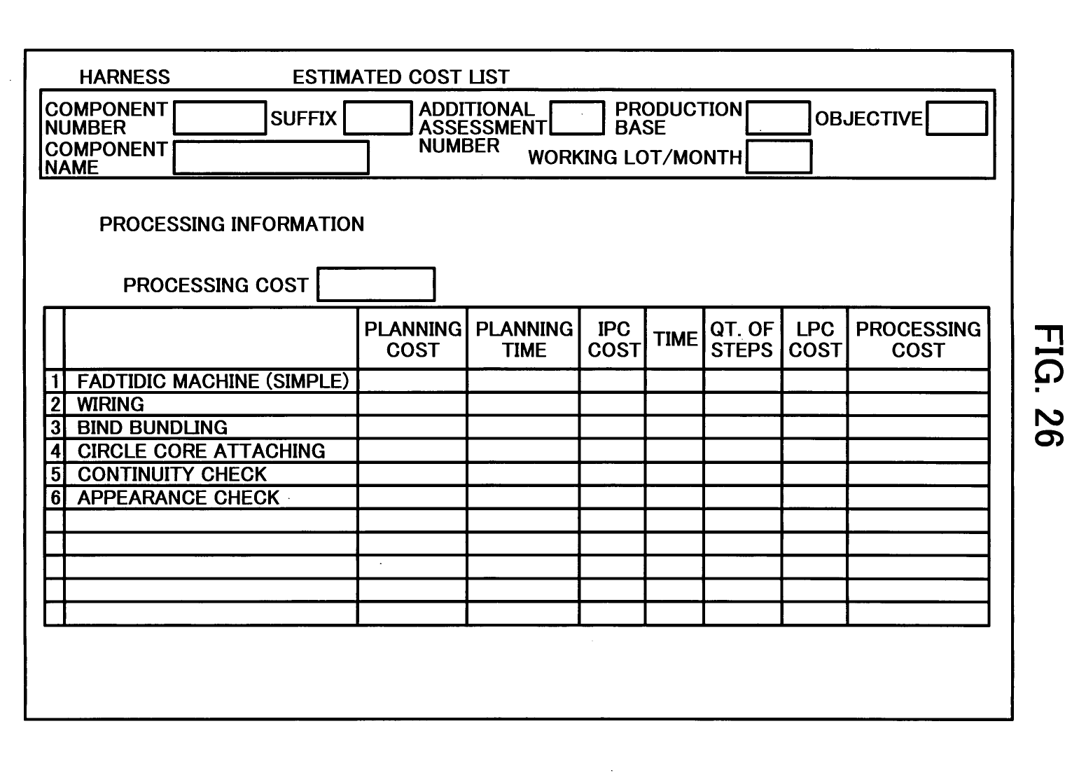

The control unit 44 first displays the unit component price screen shown in FIG. 25. The unit component price screen displays the unit component price, the material cost, the processing cost, the material loss cost, the material management cost, the general management cost, the profit margin, and the transportation/material handling cost.

Next, the control unit 44 displays the processing cost display screen shown in FIG. 26. The processing cost display screen displays the planning cost, the planning time, the instrument-proportional common cost, the work time, and the labor-proportional common cost, which are calculated in the process of calculating the processing cost, and the processing cost obtained by adding up all of these, process step by process step.

According to the present embodiment described above, the estimation system 40 receives input of calculation factors necessary for calculating the processing cost of a harness from the estimation requester, and calculates the unit component price of the harness by using the input calculation factors and pre-stored estimation functions. Accordingly, a designer of a harness can design the harness by taking the unit component price of the harness that is required for manufacturing the harness, into consideration.

The processing cost of a harness is made up of an instrument-proportional common cost calculated based on an operation time, a labor-proportional common cost calculated based on a work time, and a planning cost calculated based on a planning time. According to the present embodiment, the work time, the instrument-proportional common cost, the work time, the labor-proportional common cost, the planning time, and the planning cost, which are calculated in the process of calculating the processing cost can be displayed process step by process step. Because of this, the designer of a harness can easily grasp the breakdown of the processing cost of each process step and the time required for processing. This makes it possible for a person who needs to know the estimated cost in a business negotiation, a person who makes the process step plan, a person who plans staff member allocation, etc. to refer to the unit component price of a harness and the state of how busy it is in each process step, and to perform their own duties efficiently.

### EXAMPLE 1

A detailed example according to the above-described embodiment will now be explained. In the above-described embodiment, when values are input in the input sections for inputting calculation factors which are provided on the processing information screen, an estimation function of a corresponding process step is read out and the processing cost of the process step for which calculation factors have been input, is calculated by using the read-out estimation function.

However, according to such a calculation process, subjective opinions of the estimation requester must be relied upon in order to determine what process steps must be undergone to manufacture a harness for which estimation is requested, in other words, for what process steps the estimation requester must input calculation factors. Accordingly, the present example will describe a structure in which an inexperienced estimation requester who can not figure out the process steps necessary to manufacture a harness from a diagram showing the harness's completed state, can also be helped as to what calculation factors must be input for estimation.

In the present embodiment, a redisplayed version of the processing information screen will be output, which displays process steps (referred to as required process steps) for which calculation factors must be input without fail in a case where a harness is to be manufactured based on conditions which the estimation requester inputs from a process step setting screen displayed by clicking a process step setting guide button provided in the upper right of the processing information screen shown in FIG. 3, FIG. 5, FIG. 6, and FIG. 7, and process steps (referred to as drawing-specified process steps) for which calculation factors must be input in a case where the process steps are specified by a drawing depicting the harness for which estimation is requested, both types of process steps in different colors.

First, the process step setting screen displayed by clicking the process step setting guide button will be explained.

The process step setting screen includes an insulation-displacement-crimping step setting screen and a crimp-connecting step setting screen. If a component number of a child component displayed in the component constitution information section a4 in the main screen shown in FIG. 2 includes, for example, “1100****”, this means that a crimp-connecting machine will be used in the process step. In this case, conditions need to be input from the crimp-connecting step setting screen. On the other hand, if a displayed component number of a child component does not include “1100***”, this means that an insulation-displacement-crimping (IDC) machine will be used in the process step. In this case, conditions need to be input from the crimp-connecting step setting screen.

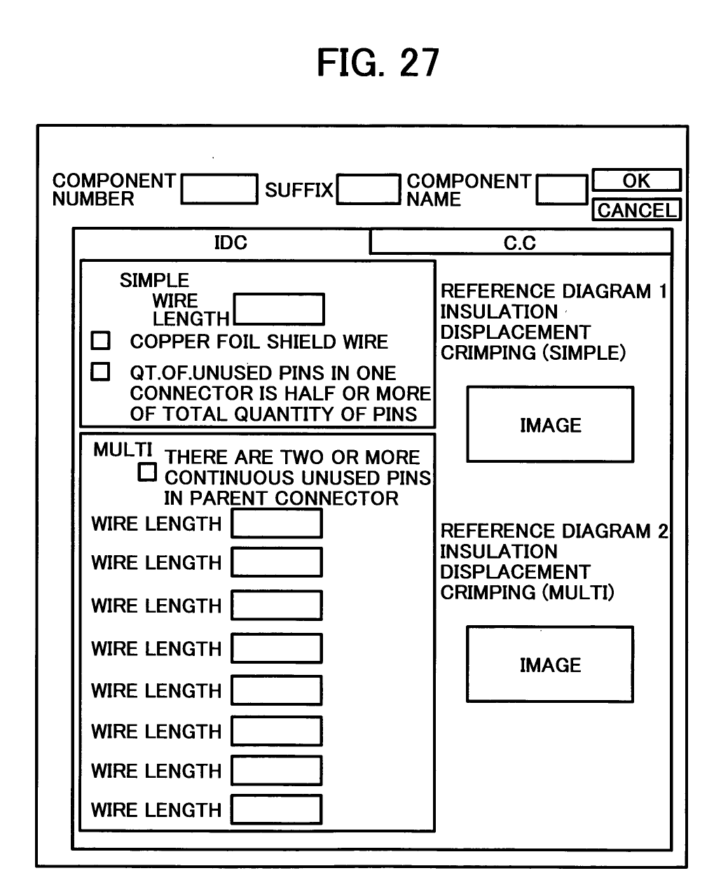

FIG. 27 shows the insulation-displacement crimping step setting screen. In a lower row of this screen, there is provided an input section for inputting wire length for insulation-displacement-crimping (simple). At the right of this input section, there is displayed a reference diagram of insulation-displacement-crimping (simple). Further, in a case where a conducting wire to be used is a copper foil shield wire, a check box is provided under the wire length input section, so that the estimation requester clicks the box.

Furthermore, in a case where the quantity of unused pins of a connector is equal to or larger than the half of the total quantity of pins of this connector, a check box is further provided under the above check box, so that the estimation requester clicks it. In the middle to lower rows of the screen, there are provided input sections for inputting wire lengths for respective harness units that need insulation-displacement-crimping (multi). At the right of these input sections, there is displayed a reference diagram of insulation-displacement-crimping (multi). In a case where there are two or more continuous pins that are unused in a parent connector, there is provided a check box above the wire length input sections so that the estimation requester checks the check box.

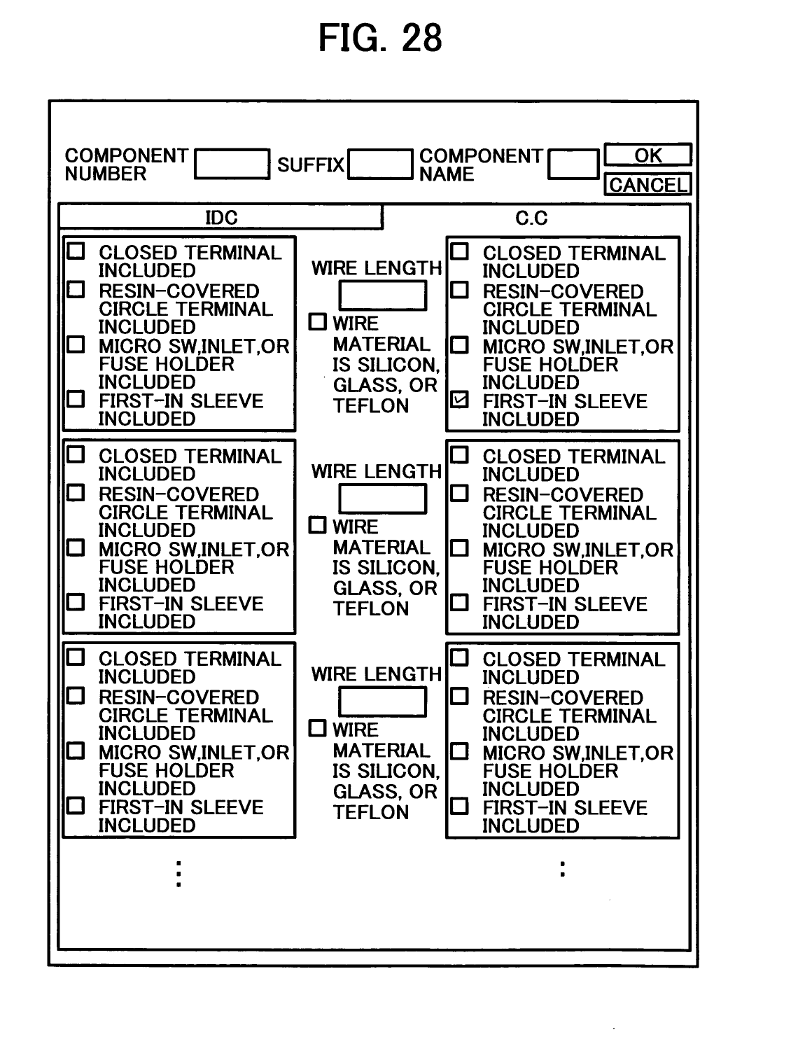

FIG. 28 shows the crimp-connecting step setting screen. In this screen, there are provided input sections for inputting wire lengths of respective harness units. Further, in a case where there are conditions such as that any terminal is a closed terminal, or a resin-covered circle terminal, or has a micro SW, an inlet, a fuse holder, or a first-in sleeve, there are provided check boxes so that the estimation requester checks corresponding ones. Furthermore, in a case where the material of wires of each harness is any of silicon, glass, and Teflon®, there is provided a check box under the wire length input section so that the estimation requester checks the check box.

The estimation requester, who has input necessary conditions from the insulation-displacement-crimping step setting screen and the crimp-connecting step setting screen, clicks an OK button provided in the upper right of the screen. Due to this, selection of required process steps and drawing-specified process steps will be started. The control unit 44 first selects an insulation-displacement-crimping machine or a crimp-connecting machine that is necessary for processing a harness by performing an insulation-displacement-crimping machine selection operation or a crimp-connecting machine selection operation. This is because required process steps and drawing-specified process steps are set in correspondence with the kinds of insulation-displacement-crimping machines or crimp-connecting machines, as will be described later.

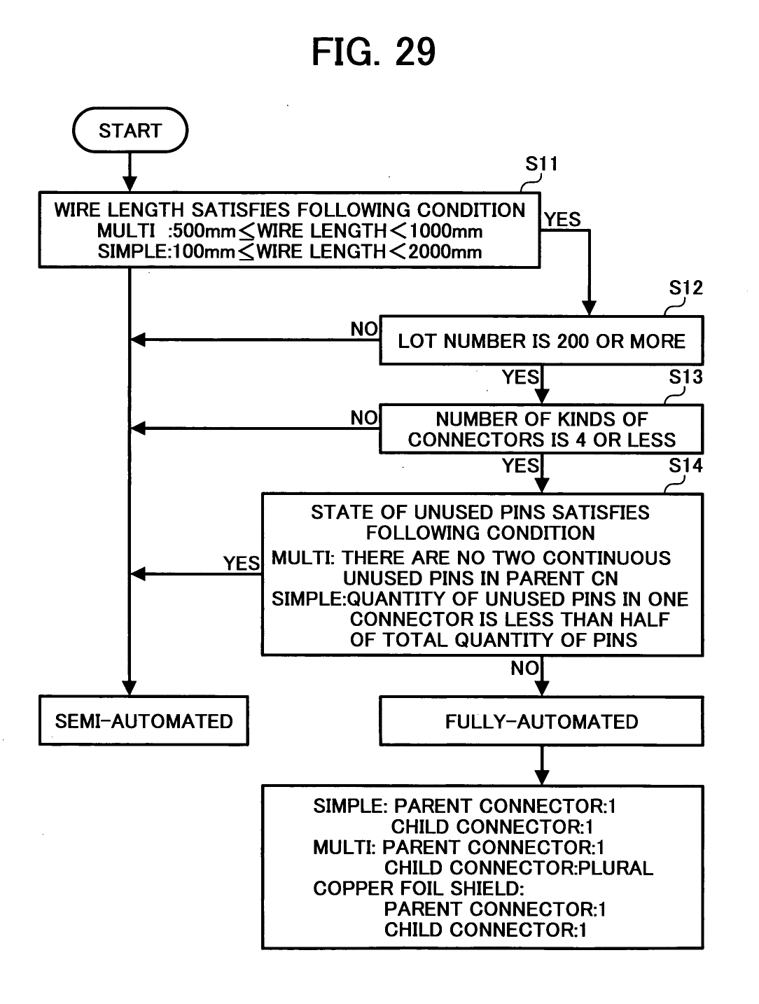

FIG. 29 shows a flowchart of the insulation-displacement-crimping machine selection operation. In a case where a component number of a child component displayed in the component constitution information section a4 in the main screen includes “1100****”, this insulation-displacement-crimping machine selection operation is performed.

First, the control unit 44 determines whether or not the wire length input in the wire length input section in the insulation-displacement-crimping step setting screen is within a pre-set range (S11). That is, the control unit 44 determines whether or not the input wire length is equal to or greater than 500 mm and equal to or smaller than 1000 mm in case of multi, and whether or not the input wire length is equal to or greater than 100 mm and equal to or smaller than 2000 mm in case of simple. In a case where determining that the input wire length is out of this range, the control unit 44 selects a semi-automated insulation-displacement-crimping machine.

In a case where determining that the input wire length is within the range, the control unit 44 determines whether or not the lot number input in the monthly lot input section a3 in the main screen is equal to or greater than 200 (S12). In a case where determining that the lot number is smaller than 200, the control unit 44 selects a semi-automated insulation-displacement-crimping machine.

In a case where determining that the lot number is equal to or greater than 200, the control unit 44 determines whether or not the number of kinds of connectors is equal to or smaller than 4 kinds (S13). In case of insulation-displacement-crimping (simple), if the component number of the parent component and the component number of the child component are different, the number of kinds of connectors is counted as 2. In case of insulation-displacement-crimping (multi), the number of kinds of connectors is the total of the numbers of pairs of parent components and child components that have different component numbers from each other. Then, in a case where determining that the number of kinds of connectors is equal to or greater than 4, the control unit 44 selects a semi-automated insulation-displacement-crimping machine.

In a case where determining that the number of kinds of connector is equal to or smaller than 4, the control unit 44 determines whether or not the state of unused pins satisfies a pre-set condition (S14). That is, the control unit 44 determines whether or not the check box for the condition that the quantity of unused pins in one connector is half or more of the total quantity of pins is clicked in case of simple, and determines whether or not the check box for the condition that the there are two or more continuous unused pins in the parent connector is clicked in case of multi. Then, in a case where determining that this condition is satisfied, the control unit 44 selects a semi-automated insulation-displacement-crimping machine.

In a case where determining that the state of unused pins doesn't satisfy the above condition, the control unit 44 selects a fully-automated insulation-displacement-crimping machine. The fully-automated insulation-displacement-crimping machine includes three types, namely “simple”, “multi”, and “copper foil shield”. The control unit 44 selects the “simple” type insulation-displacement-crimping machine in a case where the wire length is input in the wire length input section for simple in the insulation-displacement-crimping step setting screen. The control unit 44 selects the “multi” type insulation-displacement-crimping machine in a case where the wire length is input in the wire length input section for multi. The control unit 44 selects the “copper foil shield” type insulation-displacement-crimping machine in a case where the check box for copper foil shield wire is clicked in the insulation-displacement-crimping step setting screen.

Thus, the insulation-displacement-crimping machine selection operation shown in FIG. 29 is completed.

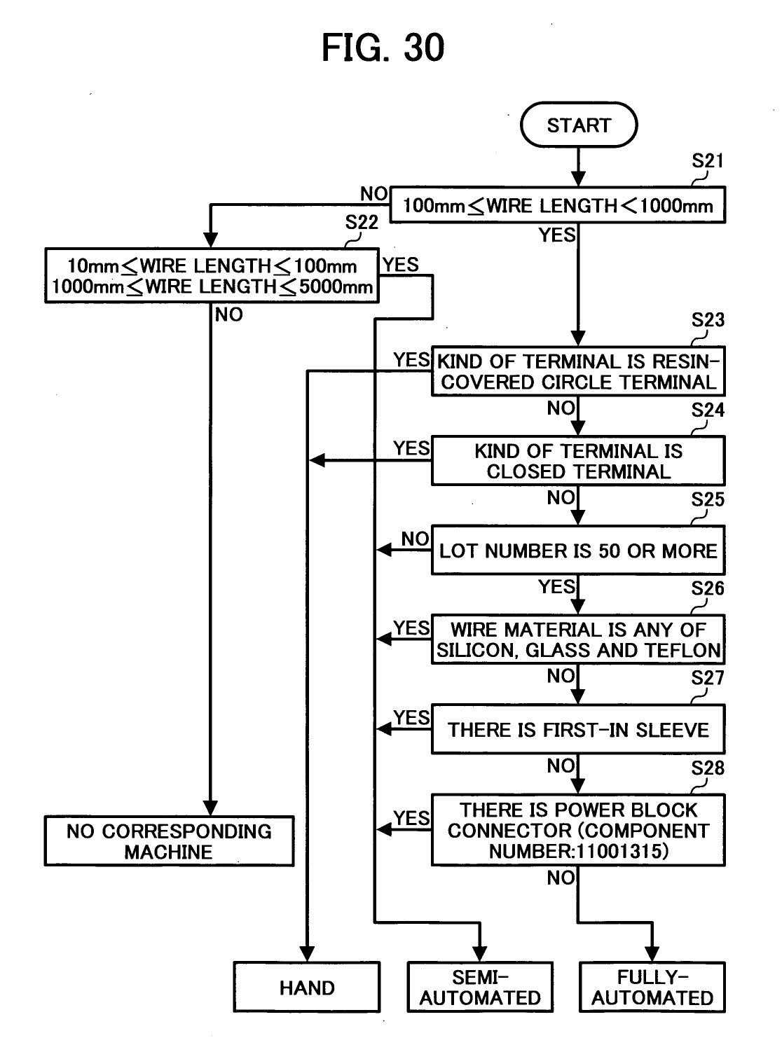

FIG. 30 shows a flowchart of the crimp-connecting machine selection operation.

The control unit 44 performs this operation in a case where a component number of a child component displayed in the component constitution information section a4 in the main screen does not include “1100****”.

First, the control unit 44 determines whether or not the wire length input in the wire length input section in the crimp-connecting step setting screen is within a pre-set range (S21). That is, the control unit 44 determines whether or not the wire length is equal to or greater than 100 mm and equal to or smaller than 1000 mm.

In a case where determining that the input wire length is not within the range, the control unit 44 determines whether or not the wire length input in the wire length input section is within another pre-set range (S22). That is, the control unit 44 determines whether or not the wire length is equal to or greater than 10 mm and smaller than 100 mm, or greater than 1000 mm and equal to or smaller than 5000 mm.

In a case where determining that the wire length is within the another pre-set range, the control unit 44 selects a semi-automated crimp-connecting (SACC) machine. On the contrary, in a case where determining that the wire length is not within the another pre-set range either, the control unit 44 selects neither required process steps nor drawing-specified process steps, by determining that there is no corresponding crimp-connecting machine.

Returning to step S21, in a case where the wire length input in the wire length input section is in the range of equal to or greater than 100 mm and equal to or smaller than 1000 mm, the control unit 44 determines whether or not the kind of terminal is a resin-covered circle terminal (S23). In a case where determining that the kind of terminal is a resin-covered circle terminal, the control unit 44 selects a hand crimp-connecting machine.

In a case where determining that the kind of terminal is not a resin-covered circle terminal, the control unit 44 determines whether or not the kind of terminal is a closed terminal (S24). In a case where determining that the kind of terminal is a closed terminal, the control unit 44 selects a hand crimp-connecting machine.

In a case where determining that the kind of terminal is not a closed terminal, the control unit 44 determines whether or not the lot number input in the monthly lot input section a3 in the main screen is equal to or greater than 50 (S25). In a case where determining that the lot number is smaller than 50, the control unit 44 selects a semi-automated crimp-connecting machine.

In a case where determining that the lot number is equal to or greater than 50, the control unit 44 determines whether or not the wire material is any of silicon, glass, and Teflon® (S26). Under the wire length input section in the crimp-connecting step setting screen, there is provided a check box for the case where the wire material is any of silicon, glass, and Teflon®. In a case where the wire material is any of silicon, glass, and Teflon® by checking the state of the check box, the control unit 44 selects a semi-automated crimp-connecting machine.

In a case where determining that the wire material is not silicon, glass, or Teflon®, the control unit 44 determines whether there is a first-in sleeve (S27). In a case where determining that there is a first-in sleeve, the control unit 44 selects a semi-automated crimp-connecting machine.

In a case where determining that there is no first-in sleeve, the control unit 44 determines whether or not there is a power block connector (S28). For example, a component number “11001315” is assigned to a power block connector.

Accordingly, in a case where the component number of any child component displayed in the component constitution information section a4 in the main screen includes “11001315”, the control unit 44 determines that there is a power block connector. Then, the control unit 44 selects a semi-automated crimp-connecting machine in a case where there is a power block connector, and selects a fully-automated crimp-connecting (FACC) machine in a case where there is no power block connector.

Thus, the crimp-connecting machine selection operation shown in FIG. 30 is completed.

The control unit 44, which has selected an insulation-displacement-crimping machine or a crimp-connecting machine to be used for processing the harness by performing the insulation-displacement-crimping machine selection operation or the crimp-connecting machine selection operation, reads out required process steps and drawing-specified process steps corresponding to the selected insulation-displacement-crimping machine or the selected crimp-connecting machine, from a process step setting table pre-stored in the storage unit 41.

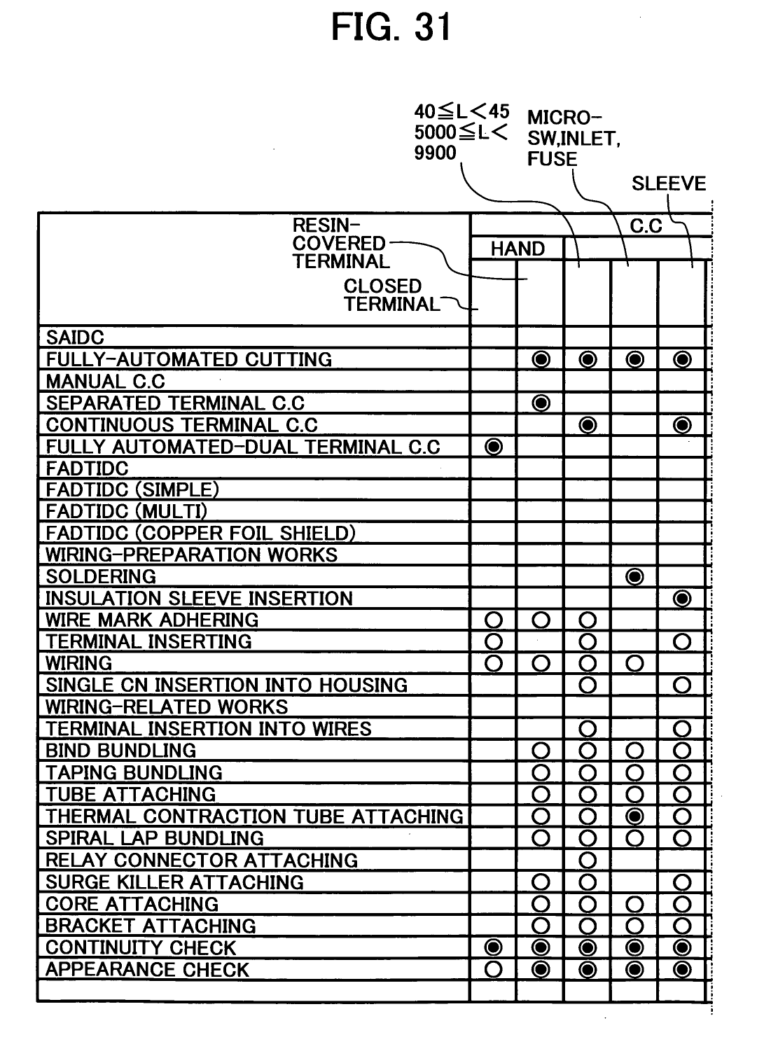

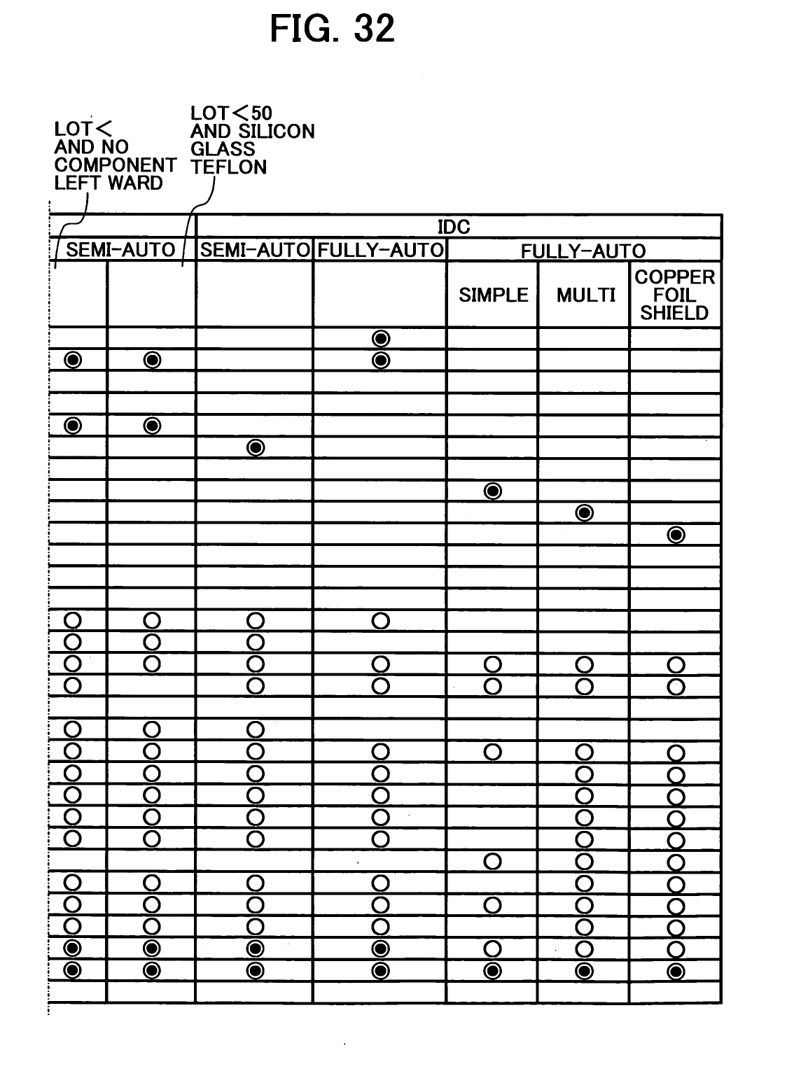

FIG. 31 and FIG. 32 show the contents of the process step setting table. The process step setting table defines required process steps and drawing-specified process steps needed when processing a harness by using each insulation-displacement-crimping machine or each crimp-connecting machine. The steps marked with a double circle in the process step setting table are required process steps, and the steps marked with a circle in the table are drawing-specified process steps. The control unit 44 reads out required process steps and drawing-specified process steps corresponding to the insulation-displacement-crimping machine or the crimp-connecting machine selected by the insulation-displacement-crimping machine selection operation or by the crimp-connecting machine selection operation, from this table.

The process step setting table defines required process steps and drawing-specified process steps by categorizing hand crimp-connecting machines into two categories and categorizing semi-automated crimp-connecting machines into five categories. The control unit 44 determines from which categories a required process step and a drawing-specified process step are to be read out, based on check marks in the crimp-connecting step setting screen. For example, the process step setting table defines the field of hand crimp-connecting machines by categorizing the machines into two categories, namely closed terminal and resin-covered circle terminal. In a case where the check box for “closed terminal included” is selected in the crimp-connecting step setting screen, the control unit 44 reads out a required process step and a drawing-specified process step from the category of closed terminal. In a case where the check box for “resin-covered circle terminal included” is selected in the crimp-connecting step setting screen, the control unit 44 reads out a required process step and a drawing-specified process step from the category of resin-covered circle terminal.

The control unit 44 outputs the processing information screen in which the required process step read out form the process step setting table is displayed in red and the drawing-specified process step read out from the process step setting table is displayed in yellow, from the output unit 43.

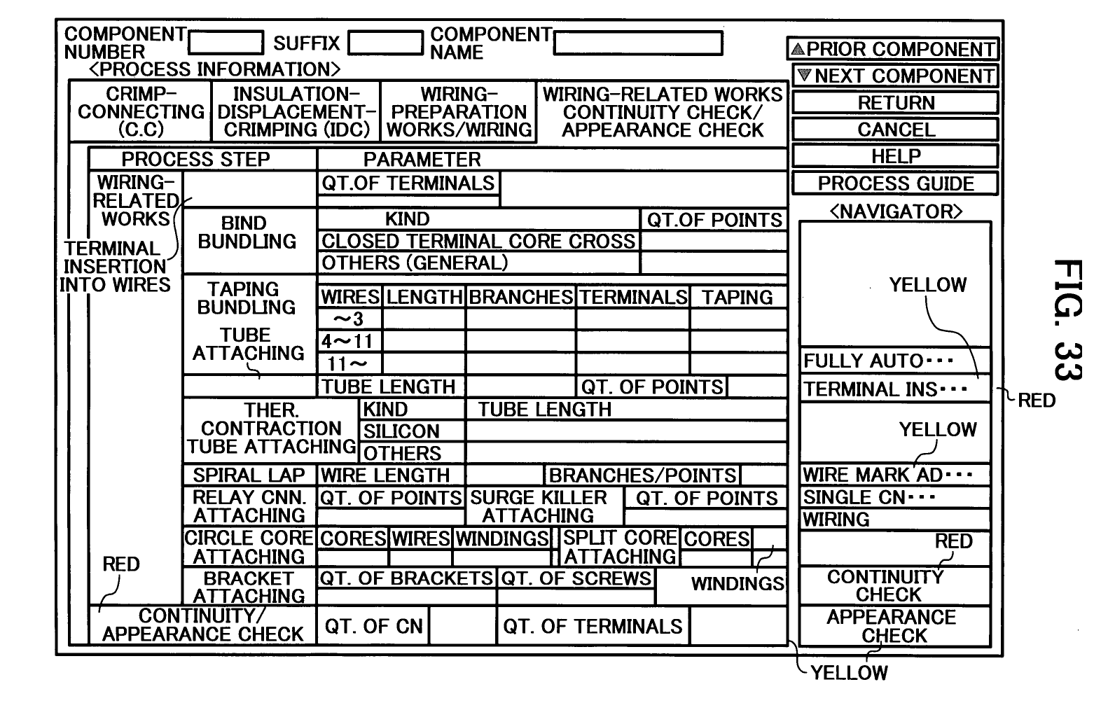

FIG. 33 is a diagram showing the processing information screen for wiring-related works/continuity check/appearance check in which the required process step and drawing-specified process step are displayed. Unlike the processing information screen shown in FIG. 7, the processing information screen shown in FIG. 33 displays the calculation factor input sections for continuity check in red, and the calculation factor input sections for appearance check in yellow.

That is, the processing information screen shown in FIG. 33 indicates that the continuity check is the required process step, the appearance check is the drawing-specified process step, and the other process steps may be arbitrarily performed. Explanation of the processing information screen for crimp-connecting, insulation-displacement-crimping, and wiring preparation works/wiring by using diagrams will be omitted. However, the required process step is likewise displayed in red and the drawing-specified process step is likewise displayed in yellow for these process steps. Further, the names of all of the process steps are displayed as navigators in the right of the processing information screen. For this navigator section, the required process step is displayed in red, and the drawing-specified process step is displayed in yellow.

By displaying the processing information screen in this manner, the estimation requester can know the process steps for which calculation factors must be input in order to estimate the processing cost of a harness, at first glance. Therefore, an inexperienced estimation requester who can not figure out the process steps necessary for manufacturing a harness from a diagram showing the harness's completed state, can also easily know for which process steps he/she should input calculation factors.

### EXAMPLE 2

Another detailed example according to the above-described embodiment will now be explained. According to the above-described embodiment, the operation time during which a harness processing instrument is operated is calculated in the middle of calculating the processing cost for each process step, and the calculated operation time is displayed on the processing cost display screen.

The present example will show a structure in which the amount of electricity consumed in each process step is calculated based on the operation time. Because the amount of electricity consumed by operation of harness processing instruments is presented, the estimation requester can know the value of the harness for which estimation is requested, not only from a financial aspect but also from an aspect of environmental aspect.

The control unit 44 calculates the amount of consumed electricity by using an electricity amount estimation function indicated by an equation (27) below.

Electricity Amount=(logical amount of consumed electricity demand ratio operation time of each process step) (27)

The control unit 44 obtains the electricity amount by calculating the product of logical amount of consumed electricity, electricity demand ratio, and operation time in the respective process steps, and adding up the obtained products.

To be more specific, logical amount of consumed electricity and electricity demand ratio can be acquired from an environmental impact information table which is pre-stored in the storage unit 41.

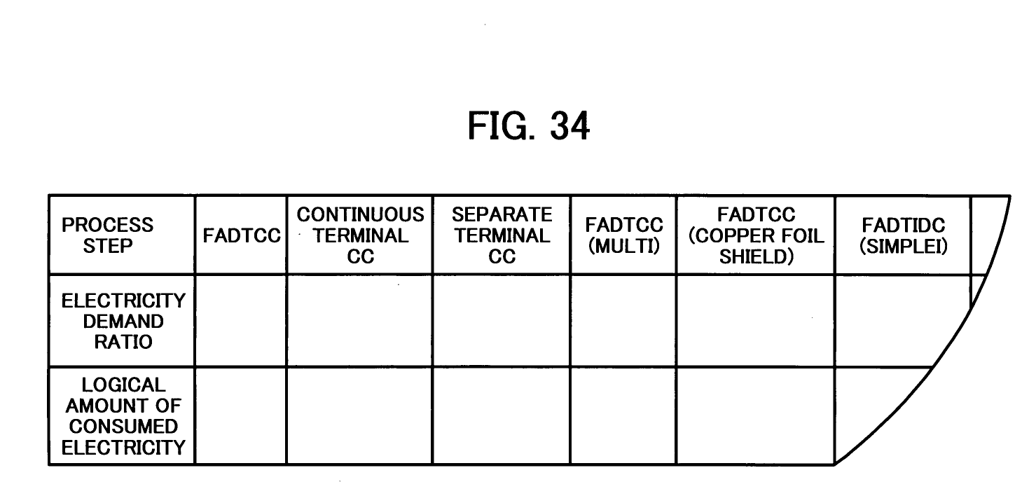

FIG. 34 is a diagram showing the content of the environmental impact information table.

The environmental impact information table defines the logical amount of consumed electricity (Kw/h) and the electricity demand ratio (%) in correspondence with each process step. The control unit 44 reads out the logical amount of consumed electricity and the electricity demand ratio of each process step from the environmental impact information table. The control unit 44 uses the operation time of each process step calculated in the above-described embodiment as the operation time of each process step in the equation (27).

[Second Embodiment]

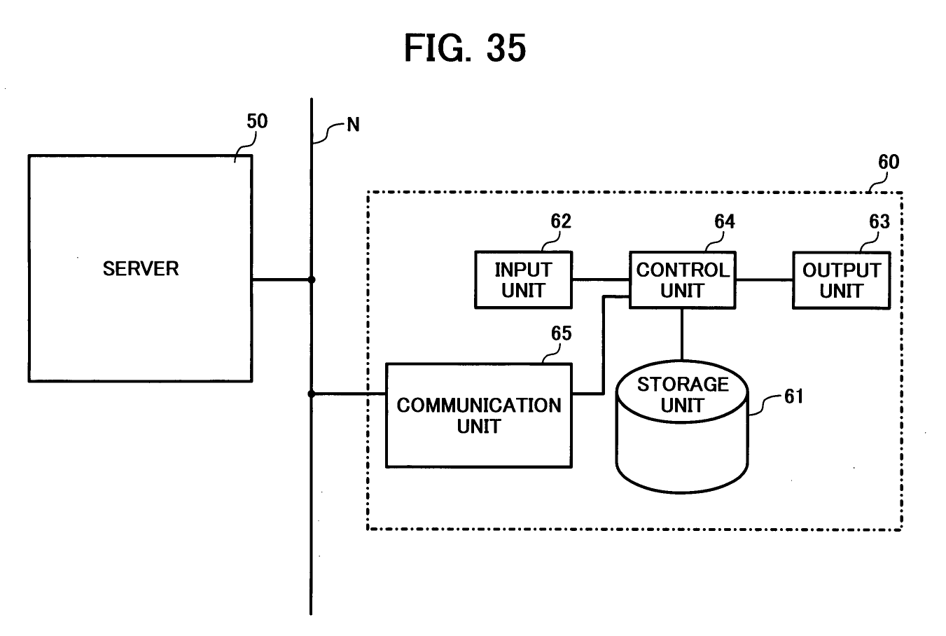

FIG. 35 is a diagram showing the structure of an estimation system according to a second embodiment of the present invention.

According to the estimation system 40 for harness processing of the first embodiment, all the estimation functions relating to harness processing are stored in the storage unit 41. However, estimation functions may be externally acquired in accordance with necessity.

An estimation system 60 for harness processing shown in FIG. 35 is a system which acquires a latest estimation function by communicating with a server 50. The estimation system 60 comprises a storage unit 61, an input unit 62, an output unit 63, a control unit 64, and a communication unit 65.

The storage unit 61, input unit 62, output unit 63, and control unit 64 are equivalent to the storage unit 41, input unit 42, output unit 43, and control unit 44 of the first embodiment. The communication unit 65 performs communication with the server 50. The communication unit 65 is connected to the control unit 64, and is also connected to the server 50 via a network N which is wired or non-wired.

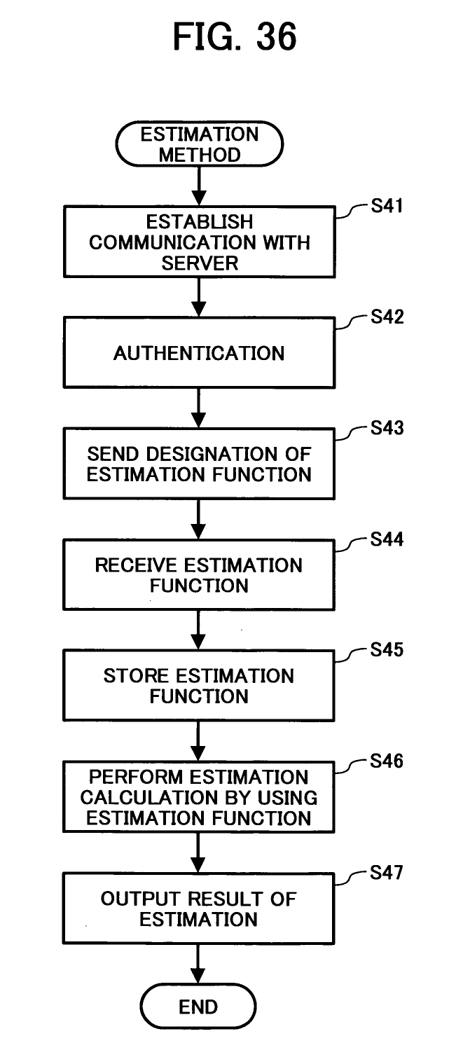

An estimation method by this estimation system 60 will now be explained with reference to FIG. 36.

An estimation function for harness processing greatly changes in accordance with improvement of work performance in a work site where actual harness processing is carried out and innovation of processing machines, etc. And such changes happen quite often. Therefore, a user who requests estimation of harness processing needs to calculate the estimation of harness processing by using the latest estimation function.

FIG. 36 shows a flowchart of an estimation method performed by the estimation system 60.

In a case where an estimation function is not stored in the storage unit 61 of the estimation system 60, or in a case where an estimation function is stored in the storage unit 61 but is outdated, the user operates the input unit 62 in order to establish communication between the server 50 and the estimation system 60. The control unit 64 calls the server 50 via the communication unit 65, and establishes communication with the server 50 (step S41).

The server 50 sends a message to the estimation system 60, in order to prompt input of, for example, an authentication number and to determine whether the user or the estimation system 60 is entitled to receive an estimation function. The control unit 64 receives the message via the communication unit 65, and outputs the message from the output unit 63. The user inputs an authentication number given to him/her beforehand from the input unit 62.

The control unit 64 sends the authentication number to the server 50 via the communication unit 65. The server 50 determines whether the user or the estimation system 60 is entitled to receive an estimation function based on the received authentication number. That is, the server 50 performs authentication (step S42).

After authentication is finished in step S42, the server 50 sends a message for the user to designate the kind of estimation function, to the estimation system 60. The control unit 64 receives the message via the communication unit 65, and outputs the message from the output unit 63.

The user designates an estimation function by operating the input unit 62. The user may partially designate necessary estimation functions or may totally designate all necessary estimation functions.

The control unit 64 sends data indicating the designated estimation function to the server 50 via the communication unit 65 (step S43). The server 50 reads out the designated estimation function from an unillustrated built-in storage device, and sends the read-out estimation function to the estimation system 60.

The control unit 64 receives the estimation function sent by the server 50 (step S44), and stores the received estimation function in the storage unit 61 (step S45).

A latest estimation function is stored in the storage unit 61 of the estimation function 60 by following step S41 to step S45. Thereafter, the control unit 64 of the estimation system 60 performs the same estimation operation as that of the first embodiment in accordance with a program (step S46). When the result of the estimation is obtained, the control unit 64 outputs the result of the estimation from the output unit 63 (step S47).

Since the estimation system 60 of the present embodiment comprises the communication unit 65 and acquires an estimation function from the server 50 as described above, the estimation system 60 can calculate the estimation of harness processing by using a latest estimation function.

Further, since the control unit 64 receives an estimation function after the server 50 performs authentication in step S42 and determines that the user or the estimation system 60 is the proper receiver of an estimation function, it is possible to prevent generally confidential estimation functions from being leaked to the outside.

[Third Embodiment]

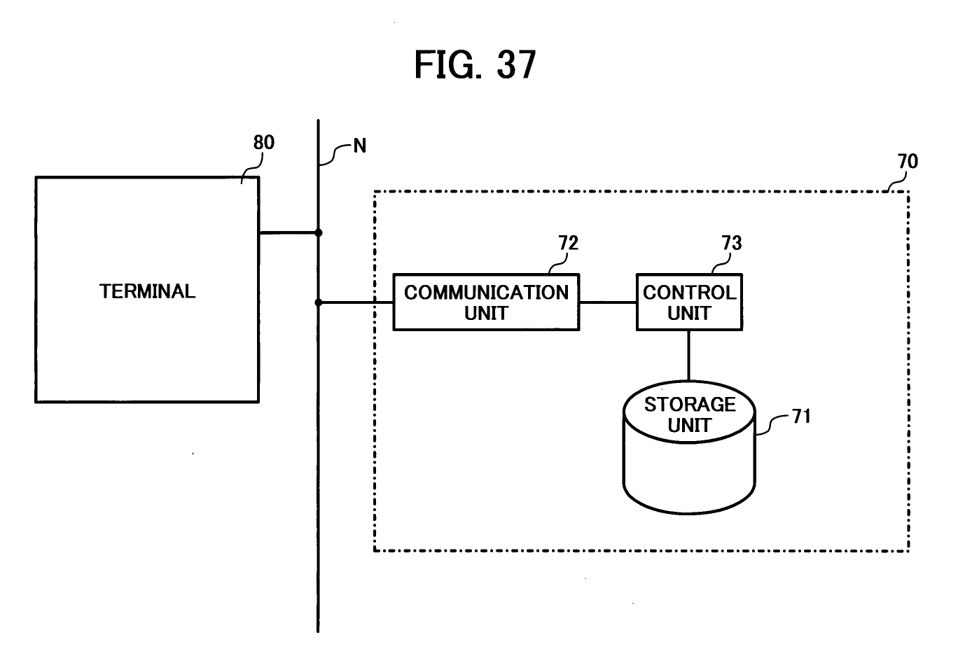

FIG. 37 is a block diagram showing an estimation system 70 according to a third embodiment of the present invention.

The estimation system 70 calculates estimation of harness processing based on a condition given by a terminal 80, and sends the calculation result to the terminal 80.

The estimation system 70 comprises a storage unit 71, a communication unit 72, and a control unit 73. The storage unit 71 and the control unit 73 are equivalent to the storage unit 41 and the control unit 44 of the first embodiment. The storage unit 71 stores estimation functions. The communication unit 72 performs communication with the terminal 80. The communication unit 72 is connected to the terminal 80 via a network N which is wired or non-wired, and is also connected to the control unit 73.

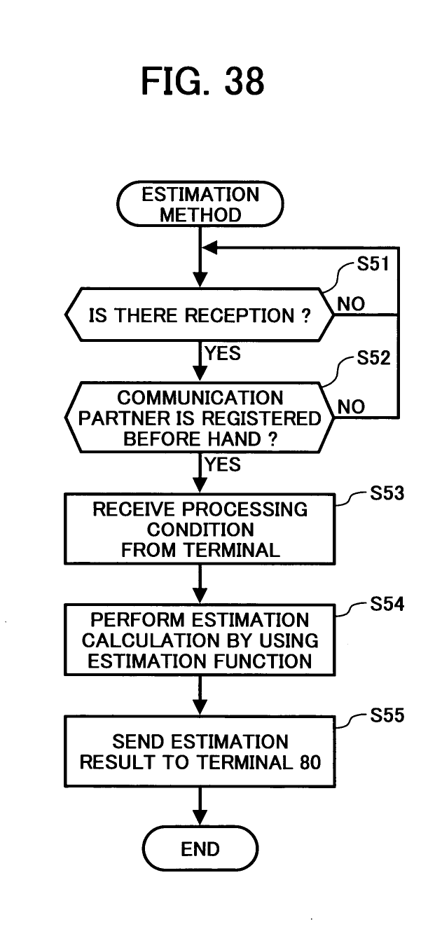

The operation of the estimation system 70 will now be explained with reference to FIG. 38.

FIG. 38 shows a flowchart of an estimation method performed by the estimation system 70.

The estimation system 70 waits for reception. If a communication route is opened and there is reception (step S51: YES), the estimation system 70 communicates with the communication partner, and determines whether the communication partner is a person registered beforehand (step S52). That is, the estimation system 70 determines whether the communication partner is a person to whom it is allowed to send an estimation result. If the communication partner is not a person to whom it is allowed to send an estimation result (step S52: NO), the estimation system 70 closes the communication route and returns to step S51.

In a case where the communication partner is the terminal 80 to which it is allowed to send an estimation result (step S52: YES), the control unit 73 keeps communicating with the terminal 80 by maintaining the communication route, and receives processing information regarding harness processing from the terminal 80 (step S53). The control unit 73 stores the processing information in the storage unit 71, and performs estimation calculation in the same manner as that of the first embodiment by using the processing information. That is, the control unit 73 performs estimation calculation by using the communication unit 72 as the input unit 42 and the output unit 43 of the first embodiment (step S54).

When an estimation result is obtained, the control unit 73 sends the estimation result to the terminal 80 via the communication unit 72 (step S55). The sent estimation result is output to the user from the terminal 80.

As described above, according to the present embodiment, the estimation system 70 comprises the communication unit 72, receives a processing condition from the terminal 80, performs estimation, and sends the estimation result to the terminal 80. Therefore, the terminal 80 needs not to comprise a mechanism for storing estimation functions or a mechanism for performing estimation calculation, which makes the structure of the terminal 80 simple. In other words, an estimation of harness processing can be obtained with the terminal 80 having a simple structure.

Further, since the control unit 73 performs estimation calculation after authenticating the terminal 80 in step S52 and determining that the user or the terminal 80 is the proper receiver of an estimation result, it is possible to prevent generally confidential estimation results from being leaked to the outside.

The embodiments and examples of the present invention are not limited to the ones described above. Those embodiments and examples can be replaced with technical means ordinarily used by those skilled in the art.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2002-275299 filed on Sep. 20, 2002 and including specification, claims, drawings and summary. The disclosure of the above Japanese Patent Application is incorporated herein by reference in its entirety.

What is claimed is:

1. An estimation system for harness processing, comprising:
a storage unit which is constituted by a memory medium or memory elements, and which stores an estimation function for calculating an estimation of a harness based on a designated processing condition for processing the harness;
an input unit which receives input of information; and
a control circuit which calculates the estimation of the harness based on the estimation function read out from said storage unit and the processing condition designated from said input unit.

2. The estimation system for harness processing according to claim 1, comprising a communication unit which receives the estimation function and stores the received estimation function in said storage unit.

3. The estimation system for harness processing according to claim 1, wherein said input unit comprises a communication unit which receives the processing condition from an external terminal and provides the received processing condition to said control circuit, and sends an estimation result for the harness calculated by said control circuit to said external terminal.

4. The estimation system for harness processing according to claim 3, wherein:
said external terminal to which the estimation result is sent is a specific terminal; and
said control circuit confirms that said external terminal is the specific terminal until at least before the estimation result is sent to said external terminal, and then sends the estimation result to said external terminal via said communication unit.

5. The estimation system for harness processing according to claim 1, wherein the estimation function for the harness is a function for calculating a unit component price of the harness based on the processing condition for the harness.

6. The estimation system for harness processing according to claim 2, wherein the estimation function for the harness is a function for calculating a unit component price of the harness based on the processing condition for the harness.

7. The estimation system for harness processing according to claim 3, wherein the estimation function for the harness is a function for calculating a unit component price of the harness based on the processing condition for the harness.

8. The estimation system for harness processing according to claim 4, wherein the estimation function for the harness is a function for calculating a unit component price of the harness based on the processing condition for the harness.

9. The estimation system for harness processing according to claim 1, comprising an output unit which outputs information,
wherein said control circuit performs:
a1) a step of acquiring the processing condition for the harness which is designated from said input unit;
b1) a step of storing the designated processing condition in said storage unit,
c1) a step of reading out the designated processing condition from said storage unit,
d1) a step of reading out the estimation function from said storage unit,
e1) a step of calculating the unit component price of the harness that corresponds to the designated processing condition, based on the read-out estimation function and a content of the designated processing condition,
f1) a step of storing the calculated unit component price in said storage unit,
g1) a step of reading out the unit component price from said storage unit, and
h1) a step of outputting the read-out unit component price via said output unit.

10. The estimation system for harness processing according to claim 1, wherein the estimation function stored in said storage unit is an operation time estimation function for calculating, based on the processing condition, an instrument operation time of each process step for processing the harness by using a harness processing instrument.

11. The estimation system for harness processing according to claim 10, wherein said control circuit performs:
a2) a step of acquiring the processing condition designated for each process step via said input unit,
b2) a step of storing the designated processing condition in said storage unit,
c2) a step of reading out the designated processing condition from said storage unit,
d2) a step of reading out the operation time estimation function from said storage unit,
e2) a step of calculating the instrument operation time of each process step based on the read-out operation time estimation function and the designated processing condition, and
f2) a step of storing the calculated instrument operation time of each process step in said storage unit.

12. The estimation system for harness processing according to claim 11, wherein:
said storage unit stores an operation cost estimation function for calculating, based on the instrument operation time, an instrument operation cost that is required for processing the harness using the harness processing instrument; and
said control circuit performs
a3) a step of reading out the calculated instrument operation time of each process step from said storage unit,
b3) a step of reading out the operation cost estimation function from said storage unit,
c3) a step of calculating the instrument operation cost of each process step based on the read-out instrument operation time of each process step and the operation cost estimation function, and
d3) a step of storing the calculated instrument operation cost of each process step in said storage unit.

13. The estimation system for harness processing according to claim 12, wherein:
said storage unit stores a work time estimation function for calculating an instrument work time which is required for processing the harness using the harness processing instrument, based on the designated processing condition; and
said control circuit performs
a4) a step of reading out the work time estimation function from said storage unit,
b4) a step of calculating the instrument work time of each process step based on the read-out work time estimation function and the designated processing condition, and
c4) a step of storing the calculated instrument work time of each process step in said storage unit.

14. The estimation system for harness processing according to claim 13, wherein:
said storage unit stores a labor cost estimation function for calculating, based on the instrument work time, an instrument labor cost that is required for processing the harness using the harness processing instrument; and
said control circuit performs
a5) a step of reading out the calculated instrument work time of each process step from said storage unit,
b5) a step of reading out the labor cost estimation function from said storage unit,
c5) a step of calculating the instrument labor cost of each process step based on the read-out instrument work time of each process step and the labor cost estimation function, and
d5) a step of storing the calculated instrument labor cost of each process step in said storage unit.

15. The estimation system for harness processing according to claim 14, wherein:
said storage unit stores a planning time estimation function for calculating, based on the designated processing condition, a planning time before processing the harness using the harness processing instrument; and
said control circuit performs
a6) a step of reading out the planning time estimation function from said storage unit,
b6) a step of calculating the planning time of each process step based on the read-out planning time estimation function and the designated processing condition, and
c6) a step of storing the calculated planning time of each processing step in said storage unit.

16. The estimation system for harness processing according to claim 15, wherein:
said storage unit stores a planning cost estimation function for calculating, based on the planning time, a planning cost required for processing the harness using the harness processing instrument; and
said control circuit performs
a7) a step of reading out the calculated planning time of each process step from said storage unit,
b7) a step of reading out the planning cost estimation function from said storage unit,
c7) a step of calculating the planning cost of each process step based on the read-out planning time of each process step and the planning cost estimation function, and
d7) a step of storing the calculated planning cost of each process step in said storage unit.

17. The estimation system for harness processing according to claim 16, wherein said control circuit performs:
a8) a step of reading out the calculated instrument operation cost, instrument labor cost, and planning cost of each process step from said storage unit,
b8) a step of calculating a processing cost required for processing the harness using the harness processing instrument, by adding up the read-out instrument operation cost, instrument labor cost, and planning cost, and
c8) a step of storing the calculated processing cost in said storage unit.

18. The estimation system for harness processing according to claim 17, comprising an output unit which outputs information,
wherein said control circuit performs:
a9) a step of reading out the calculated processing cost from said storage unit, and
b9) a step of outputting the read-out processing cost via said output unit.

19. The estimation system for harness processing according to claim 18, wherein said control circuit performs:
a10) a step of reading out the calculated instrument operation time, instrument work time, and planning time from said storage unit, and
b10) a step of outputting the read-out instrument operation time, instrument work time, and planning time via said output unit.

20. An estimation system comprising: a storage unit which stores information; an input unit which receives input of information; and a control circuit which controls operations of said storage unit and input unit,
wherein:
said storage unit stores a component database associating a quantity of child components necessary for manufacturing each harness and a unit child component price of the child components with identification information of each harness, and also stores a material cost estimation function for calculating a material cost of each harness by inputting thereto, the quantity and the unit child component price; and
said control circuit performs
a11) a step of acquiring identification information of a harness for which estimation is to be made via said input unit,
b11) a step of reading out the quantity and the unit child component price associated with the acquired identification information of the harness from the component database in said storage unit,
c11) a step of reading out the material cost estimation function from said storage unit,
d11) a step of calculating the material cost of the harness corresponding to the acquired identification information, based on the read-out material cost estimation function and the read-out quantity of child components and unit child component price, and
e11) a step of storing the calculated material cost in said storage unit.

21. The estimation system according to claim 20, comprising an output unit which outputs information,
wherein said control circuit performs
a12) a step of creating a component screen displaying the read-out quantity of child components and unit child component price, and outputting the created component screen via said output unit,
b12) a step of acquiring a change of the quantity of child components and/or unit child component price displayed on the component screen, via said input unit, and
c12) a step of calculating the material cost of the harness based on the changed quantity and unit child component price and the material cost estimation function.

22. An estimation method for harness processing, wherein in a system comprising: a storage unit which is constituted by a memory medium or memory elements, and which stores an estimation function for calculating an estimation of a harness based on a designated processing condition for processing the harness; a control circuit; and an input unit which receives input of information;
said estimation method causes said control circuit to calculate the estimation of the harness based on the estimation function read out from said storage unit and the processing condition designated from said input unit.

23. The estimation method for harness processing according to claim 22, wherein:
a communication unit is provided to said system; and
said estimation method causes said communication unit to receive the estimation function and store the received estimation function in said storage unit.

24. The estimation method for harness processing according to claim 23, wherein:
a communication unit is provided to said input unit; and
said estimation method causes said communication unit to receive the processing condition from an external terminal, provide the received processing condition to said control circuit, and send an estimation result for the harness calculated by said control circuit to said external terminal.

25. A program, wherein in a system comprising: a storage unit which is constituted by a memory medium or memory elements, and which stores an estimation function for calculating an estimation of a harness based on a designated processing condition for processing the harness; and an input unit which receives input of information; and a control circuit, said program controls said control circuit to perform an operation of calculating the estimation of the harness based on the estimation function read out from said storage unit and the processing condition designated from said input unit.

26. The program according to claim 25, wherein said system comprises a communication unit which receives the estimation function and stores the received estimation function in said storage unit.

27. The program according to claim 25, wherein the input unit comprises a communication unit which receives the processing condition from an external terminal, provides the received processing condition to said control circuit, and sends an estimation result for the harness calculated by said control circuit to said external terminal.

28. The program according to claim 27, wherein:
said external terminal to which the estimation result is sent is a specific terminal; and
said program controls said control circuit to confirm that said external terminal is the specific terminal until at least before the estimation result is sent to said external terminal, and then send the estimation result to said external terminal via said communication unit.

29. The program according to claim 25, wherein the estimation function for the harness is a function for calculating a unit component price of the harness based on the processing condition for the harness.

30. The program according to claim 26, wherein the estimation function for the harness is a function for calculating a unit component price of the harness based on the processing condition for the harness.

31. The program according to claim 27, wherein the estimation function for the harness is a function for calculating a unit component price of the harness based on the processing condition for the harness.

32. The program according to claim 28, wherein the estimation function for the harness is a function for calculating a unit component price of the harness based on the processing condition for the harness.

33. The program according to claim 25, wherein:
said system comprises an output unit which outputs information; and
said program controls said control circuit to perform
a1) a step of acquiring the processing condition for the harness which is designated from said input unit,
b1) a step of storing the designated processing condition in said storage unit,
c1) a step of reading out the designated processing condition from said storage unit,
d1) a step of reading out the estimation function from said storage unit,
e1) a step of calculating the unit component price of the harness that corresponds to the designated processing condition, based on the read-out estimation function and a content of the designated processing condition,
f1) a step of storing the calculated unit component price in said storage unit,
g1) a step of reading out the unit component price from said storage unit, and
h1) a step of outputting the read-out unit component price via said output unit.

34. The program according to claim 25, wherein the estimation function stored in said storage unit is an operation time estimation function for calculating, based on the processing condition, an instrument operation time of each process step for processing the harness during which a harness processing instrument is operated.

35. The program according to claim 34, controlling said control circuit to perform:
a2) a step of acquiring the processing condition designated for each process step via said input unit,
b2) a step of storing the designated processing condition in said storage unit,
c2) a step of reading out the designated processing condition from said storage unit,
d2) a step of reading out the operation time estimation function from said storage unit,
e2) a step of calculating the instrument operation time of each process step based on the read-out operation time estimation function and the designated processing condition, and
f2) a step of storing the calculated instrument operation time of each process step in said storage unit.

36. The program according to claim 35, wherein:
said storage unit stores an operation cost estimation function for calculating, based on the instrument operation time, an instrument operation cost that is required for processing the harness using the harness processing instrument; and
said program controls said control circuit to perform
a3) a step of reading out the calculated instrument operation time of each process step from said storage unit,
b3) a step of reading out the operation cost estimation function from said storage unit,
c3) a step of calculating the instrument operation cost of each process step based on the read-out instrument operation time of each process step and the operation cost estimation function, and
d3) a step of storing the calculated instrument operation cost of each process step in said storage unit.

37. The program according to claim 36, wherein:
said storage unit stores a work time estimation function for calculating an instrument work time which is required for processing the harness using the harness processing instrument, based on the designated processing condition; and
said program controls said control circuit to perform
a4) a step of reading out the work time estimation function from said storage unit,
b4) a step of calculating the instrument work time of each process step based on the read-out work time estimation function and the designated processing condition, and
c4) a step of storing the calculated instrument work time of each process step in said storage unit.

38. The program according to claim 37, wherein:
said storage unit stores a labor cost estimation function for calculating, based on the instrument work time, an instrument labor cost that is required for processing the harness using the harness processing instrument; and
said program controls said control circuit to perform
a5) a step of reading out the calculated instrument work time of each process step from said storage unit,
b5) a step of reading out the labor cost estimation function from said storage unit,
c5) a step of calculating the instrument labor cost of each process step based on the read-out instrument work time of each process step and the labor cost estimation function, and
d5) a step of storing the calculated instrument labor cost of each process step in said storage unit.

39. The program according to claim 38, wherein:
said storage unit stores a planning time estimation function for calculating, based on the designated processing condition, a planning time before processing the harness using the harness processing instrument; and
said program controls said control circuit to perform
a6) a step of reading out the planning time estimation function from said storage unit,
b6) a step of calculating the planning time of each process step based on the read-out planning time estimation function and the designated processing condition, and
c6) a step of storing the calculated planning time of each processing step in said storage unit.

40. The program according to claim 39, wherein:
said storage unit stores a planning cost estimation function for calculating, based on the planning time, a planning cost required for processing the harness using the harness processing instrument; and
said program controls said control circuit to perform
a7) a step of reading out the calculated planning time of each process step from said storage unit,
b7) a step of reading out the planning cost estimation function from said storage unit,
c7) a step of calculating the planning cost of each process step based on the read-out planning time of each process step and the planning cost estimation function, and
d7) a step of storing the calculated planning cost of each process step in said storage unit.

41. The program according to claim 40, controlling said control circuit to perform:
a8) a step of reading out the calculated instrument operation cost, instrument labor cost, and planning cost of each process step from said storage unit;
b8) a step of calculating a processing cost required for processing the harness using the harness processing instrument, by adding up the read-out instrument operation cost, instrument labor cost, and planning cost; and
c8) a step of storing the calculated processing cost in said storage unit.

42. The program according to claim 41, wherein:
said system comprises an output unit which outputs information; and
said program controls said control circuit to perform
a9) a step of reading out the calculated processing cost from said storage unit, and
b9) a step of outputting the read-out processing cost via said output unit.

43. The program according to claim 42, controlling said control circuit to perform:
a10) a step of reading out the calculated instrument operation time, instrument work time, and planning time from said storage unit; and
b10) a step of outputting the read-out instrument operation time, instrument work time, and planning time via said output unit.
